(19) United States
(12) Patent Application Publication
(10) Pub. No.: US 2024/0371275 A1
(43) Pub. Date: Nov. 7, 2024

(54) Systems and Methods for Assigning and Deploying Aircraft into Skylanes

(71) Applicant: Joby Aero, Inc., Santa Cruz, CA (US)

(72) Inventors: Christabelle Simone Juliette Bosson, Mountain View, CA (US); Eric Richard Mueller, San Francisco, CA (US); Thomas Prevot, San Jose, CA (US)

(21) Appl. No.: 18/654,533

(22) Filed: May 3, 2024

Related U.S. Application Data
(60) Provisional application No. 63/499,950, filed on May 3, 2023.

(51) Int. Cl. G08G 5/00; B64C 29/00; G06Q 10/047

(52) U.S. Cl. CPC G08G 5/003; G06Q 10/047; G08G 5/0026; B64C 29/00

(57) ABSTRACT

A method of assigning an electric vertical takeoff and landing (eVTOL) aircraft to a skylane includes accessing: (i) a trip request for aerial transport at a particular travel time from an origin location to a destination location within a particular geographic area; and (ii) skylane network data indicative of a plurality of skylanes for eVTOL aircraft travel in the particular geographic area. A subset of the plurality of skylanes are computed as candidate skylanes for servicing the trip request. The candidate skylanes are determined based on a route assessment configured to evaluate an operating constraint associated with respective skylanes relative to parameter data for the particular geographic area at the particular travel time. A selected skylane is computed from the candidate skylanes for servicing the trip request, and a trip assignment is generated for deployment of an eVTOL aircraft from the origin location into the selected skylane.

### PRIORITY CLAIM

This application claims priority to and the benefit of U.S. Provisional Patent Application No. 63/499,950 filed on May 3, 2023. This application is incorporated by reference herein in its entirety and for all purposes.

### FIELD

The present disclosure relates generally to aviation transport networks, and in particular to dynamic aircraft routing using a network of skylanes.

### BACKGROUND

A vertical takeoff and landing (VTOL) aircraft can transition from a vertical takeoff state to travel vertically and a cruise state to move forward. For example, a vertical takeoff state can use propellers to generate lift. The cruise state uses wings to generate lift and rotate the propellers to generate thrust. Similar elements can be used for landing the VTOL. The VTOL can utilize this functionality to transport passengers from one location to another. Transportation service applications can allow passengers to request transportation and computing platforms can be used to help facilitate these services.

### SUMMARY

Aspects and advantages of implementations of the present disclosure will be set forth in part in the following description, or may be learned from the description, or may be learned through practice of the implementations.

One example aspect of the present disclosure is directed to a method of assigning an electric vertical takeoff and landing (eVTOL) aircraft to a skylane. The method includes accessing a trip request for aerial transport at a particular travel time from an origin location to a destination location within a particular geographic area. The method includes accessing skylane route network data indicative of a plurality of skylanes for eVTOL aircraft travel in the particular geographic area. The method includes computing a subset of the plurality of skylanes as candidate skylanes for servicing the trip request. The candidate skylanes are determined based on a route assessment configured to evaluate an operating constraint associated with respective skylanes relative to parameter data for the particular geographic area at the particular travel time. The method includes computing a selected skylane from the candidate skylanes for servicing the trip request. The method includes generating a trip assignment for deployment of an eVTOL aircraft from the origin location into the selected skylane.

Another example aspect of the present disclosure is directed to one or more non-transitory computer-readable media storing instructions that are executable by one or more processors to perform operations. The operations include accessing a trip request for aerial transport at a particular travel time from an origin location to a destination location within a particular geographic area. The operations include accessing skylane route network data indicative of a plurality of skylanes for eVTOL aircraft travel in the particular geographic area. The operations include computing a subset of the plurality of skylanes as candidate skylanes for servicing the trip request. The candidate skylanes are determined based on a route assessment configured to evaluate an operating constraint associated with respective skylanes relative to parameter data for the particular geographic area at the particular travel time. The operations include computing a selected skylane from the candidate skylanes for servicing the trip request. The operations include generating a trip assignment for deployment of an eVTOL aircraft from the origin location into the selected skylane.

Yet another example aspect of the present disclosure is directed to a computing system. The computing system includes one or more processors and one or more non-transitory computer-readable media storing instructions that are executable by the one or more processors to perform operations. The operations include accessing a trip request for aerial transport at a particular travel time from an origin location to a destination location within a particular geographic area. The operations include accessing skylane route network data indicative of a plurality of skylanes for eVTOL aircraft travel in the particular geographic area. The operations include computing a subset of the plurality of skylanes as candidate skylanes for servicing the trip request. The candidate skylanes are determined based on a route assessment configured to evaluate an operating constraint associated with respective skylanes relative to parameter data for the particular geographic area at the particular travel time. The operations include computing a selected skylane from the candidate skylanes for servicing the trip request. The operations include generating a trip assignment for deployment of an eVTOL aircraft from the origin location into the selected skylane.

Other example aspects of the present disclosure are directed to other systems, methods, vehicles, apparatuses, tangible non-transitory computer-readable media, and devices for dynamically determining and updating a network of skylanes, as well as assigning eVTOL aircraft to such skylanes for air travel.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example journey of a multi-modal transportation service according to example implementations of the present disclosure.

FIG. 2 depicts a map diagram of an example multi-modal transportation itinerary and aerial routes according to example implementations of the present disclosure.

FIG. 3 depicts a graphical representation of an example aerial facility according to example embodiments of the present disclosure.

FIG. 4 depicts an example computing system for providing a multi-modal transportation service according to example implementations of the present disclosure.

FIG. 5 depicts an example networked ecosystem of example computing systems for providing a multi-modal transportation system according to example implementations of the present disclosure.

FIG. 6 depicts a block diagram of an example dynamic aircraft routing system according to example implementations of the present disclosure.

FIG. 7 depicts a map diagram of example aircraft track data according to example implementations of the present disclosure.

FIG. 8 depicts a map diagram of example restricted zone data according to example implementations of the present disclosure.

FIG. 9 depicts a map diagram of example airspace data according to example implementations of the present disclosure.

FIG. 10 depicts a map diagram of example skylanes according to example implementations of the present disclosure.

FIG. 11 depicts a block diagram of an example portion of a skylane network according to example implementations of the present disclosure;

FIG. 12 depicts a block diagram of activated skylanes in the skylane network of FIG. 11 according to example implementations of the present disclosure.

FIG. 13 depicts a block diagram of an example portion of a skylane network and example parameter data for a particular geographic area according to example implementations of the present disclosure.

FIG. 14 depicts a block diagram of activated skylanes in the skylane route network of FIG. 13 according to example implementations of the present disclosure.

FIG. 15 depicts an example aspect of a skylane network according to example implementations of the present disclosure.

FIG. 16 depicts an example skylane spacing layout according to example implementations of the present disclosure.

FIG. 17 depicts a flowchart diagram of an example method for generating a skylane network for aircraft travel in a particular geographic area according to example implementations of the present disclosure.

FIG. 18 depicts a flowchart diagram of an example method for computing skylane route data for a particular skylane according to example implementations of the present disclosure.

FIG. 19 depicts a flowchart diagram of an example method for dynamically updating a skylane network for aircraft travel in a particular geographic area according to example embodiments of the present disclosure.

FIG. 20 depicts a flowchart diagram of an example method for computing a route assessment according to example embodiments of the present disclosure.

FIG. 21 depicts a flowchart diagram of an example method for activating available skylanes according to example embodiments of the present disclosure.

FIG. 22 depicts a flowchart diagram of an example method for deploying a particular eVTOL aircraft to travel on a particular skylane according to example embodiments of the present disclosure.

FIGS. 23A-B depict a flowchart diagram of an example method of assigning an eVTOL aircraft to a skylane according to example embodiments of the present disclosure.

FIG. 24 depicts a flowchart diagram of an example method for computing a selected skylane from candidate skylanes according to example embodiments of the present disclosure.

FIG. 25 depicts a flowchart diagram of an example method of computing a plurality of candidate aircraft from a fleet of aircraft for servicing a trip request according to example embodiments of the present disclosure.

FIG. 26 depicts a flowchart diagram of an example method of computing a selected aircraft from the plurality of candidate aircraft for servicing a trip request according to example embodiments of the present disclosure.

FIG. 27 depicts a flowchart diagram of an example method of computing a departure time for deployment of a selected aircraft according to example embodiments of the present disclosure.

FIG. 28 depicts a block diagram of an example computing system according to example embodiments of the present disclosure.

### DETAILED DESCRIPTION

Generally, the present disclosure is directed to improved solutions for aviation transport networks, particularly for vertical takeoff and landing (VTOL) aircraft. More particularly, the computing technology described herein is directed to assigning and deploying aircraft into skylanes. A computing system (e.g., of an aerial transportation network) can include assignment generation engines, which can determine particular skylanes and/or aircraft for servicing trip requests within a transportation ecosystem. For example, the computing system can access data indicative of a request for aerial transportation indicating a user's desire to travel from a first vertiport (e.g., aerial transport hub) to a second vertiport. The computing system may identify that a particular skylane is available for such a route and will be available within the desired timeframe. Additionally, or alternatively, the computing system can determine that a particular aircraft (e.g., an eVTOL of manufacturer A) is available and suitable to transport the user and would be appropriate for the particular skylane given the aircraft's noise envelope, size, etc. In some implementations, the aircraft may be selected first and the computing system may determine (or refine) a particular skylane for the selected aircraft. These skylane and aircraft determinations can be based on aircraft itinerary, types of aircraft and operators/owners, aircraft operating characteristics, skylane route assessments, etc.

The computing system may also be configured to intelligently deploy aircraft into skylanes based on a timing sequence. For instance, as further described herein, the computing system may determine a timing sequence for deploying aircraft into the same, or adjacent, skylanes to avoid, for example, noise constrain violations. The computing system can do so while also ensuring that riders are able to reach their ultimate destinations within the estimated times of arrival. Deploying an eVTOL aircraft in accordance with the described techniques thus means to strategically initiate motion or launch of the eVTOL aircraft, by providing deployment instructions to: (i) a pilot operating the eVTOL aircraft and/or (ii) a control system onboard the eVTOL aircraft.

Air travel has conventionally been limited compared to ground travel. Air travel can have a number of requirements making air travel difficult. For instance, aircraft can require significant resources such as fuel and infrastructure (e.g., runways) and require significant time for passenger entry and exit, each presenting technical challenges for achieving a larger volume of air travel within particular geographic areas or between neighboring locations. However, providing such air travel may reduce travel time over purely ground-based approaches as well as alleviate problems associated with traffic congestion.

Vertical takeoff and landing (VTOL) aircraft provide opportunities to incorporate aerial transportation into transport networks for cities and metropolitan areas. VTOL aircraft require much less space to take off and land relative to traditional aircraft. In addition, developments in battery technology have made electric VTOL (eVTOL) aircraft technically and commercially viable. EVTOL aircraft may be quieter than aircraft using other power sources or propulsion systems, which further increases their viability for use in built-up areas where noise may be a concern. Although some aspects of the present disclosure are described relative to VTOL and/or eVTOL aircraft, the subject technology can be applied to any aircraft including all types of VTOL and non-VTOL aircraft, such as but not limited to electric VTOL, hydrogen-electric VTOL, rotary-wing aircraft, and smaller/slower fixed wing aircraft (e.g., propeller planes).

Operating eVTOL aircraft within a dense urban environment involves more complex operating constraints than traditional commercial aviation. For instance, aerial rideshare services may utilize eVTOL aircraft to fly at lower altitudes and tighter flight corridors, which introduces additional noise and maneuverability constraints. Vertiports for takeoff and landing of eVTOL aircraft may also be designated in unique locations relative to traditional aviation. Traditional aircraft routing techniques lack the computational flexibility to properly allocate airspace for these more dynamic operating conditions.

The techniques described herein to assign and deploy aircraft into skylanes are intended to address the aforementioned challenges in aircraft routing for eVTOL aircraft. Additional aspects of the present disclosure are also intended to address the aforementioned challenges.

Another example aspect of the present disclosure is directed to systems and methods for generating a skylane network. A skylane network can include all the skylanes for a particular geographic area. As described herein, a skylane includes a three-dimensional volume of airspace that encapsulates a route for the VTOL aircraft to travel from one location to another. The technology of the present disclosure can dynamically generate a skylane network for VTOL aircraft by leveraging airspace data from other types of aircraft. The resultant skylane network can be particularly useful for routing VTOL aircraft in a particular geographic area, such as a dense urban environment.

More particularly, a computing system can generate a directed graph representation of a skylane network. The skylane network can include all the skylanes for a particular geographic area. Each skylane can be represented by a three-dimensional volume of airspace surrounding an aircraft route. More particularly, a skylane can be defined by a plurality of waypoints in three-dimensional space between a first location (e.g., an origin vertiport) and a second location (e.g., a destination vertiport). The directed graph representation of the skylane network can include nodes and edges for each respective skylane.

For a new skylane in the network, the computing system can access airspace data including aircraft track data and/or restricted zone data. The aircraft track data can indicate locations of one or more aircraft (e.g., eVTOL aircraft, helicopters or other rotary-wing aircraft, or other aircraft having similar operational parameters as eVTOL aircraft) during one or more routes previously traveled in a particular geographic area. The restricted zone data can indicate locations within a particular geographic area that are unavailable for eVTOL aircraft travel, such as no-fly zones or locations associated with takeoff and landing paths for other larger/faster aircraft (e.g., fixed-wing aircraft such as turbo props and/or jets).

The computing system can generate skylanes for eVTOL aircraft travel based on the aircraft track data and/or restricted zone data by creating waypoints between first and second locations, each corresponding to nodes within the directed graph. In some implementations, the computing system can generate map-based representations of the skylanes for presentation via a user interface.

Another example aspect of the present disclosure is directed to systems and methods for dynamically updating a skylane network for improved aviation transport by VTOL aircraft. For example, a computing system (e.g., of an aerial transportation network) can continuously refine a skylane network by dynamically updating individual skylanes and/or segments of associated routes based on aircraft location data, runway use data, noise limit data, weather data, payload data, or other constraint parameter data. Dynamic skylane updates include changes that are made to compensate based on other factors (e.g., to make up for user/aircraft delays, additional charging, avoid user ETA violations, etc.). This can also include changing the skylanes based on changes in visual and auditory noise, demand, etc. The skylane network can be updated in real-time based on constraints that are unique to operating VTOL aircraft for relatively short-range, ridesharing transport applications. Moreover, the technology can improve aircraft operations by intelligently assigning VTOL aircraft to particular skylanes based on timing sequences, aircraft type, and other parameters to improve transportation efficiency, while avoid violating the operating constraints.

As described herein, a skylane includes a three-dimensional volume of airspace that encapsulates a route for the VTOL aircraft to travel from one location to another. To change the skylane, the computing system can revise, remove, or replace skylanes as well as individual segments of a particular skylane. By way of example, the computing system can adjust particular waypoints of a skylane to re-route the skylane to avoid an eVTOL flying in an area experiencing a temporary restriction on environmental noise (e.g., to do a graduation). In another example, the computing system can adjust the dimensions of the skylane (e.g., to increase the height of a volume above the route) to allow an aircraft to fly at higher altitudes to decrease noise impacts at the ground level. In another example, the computing system may adjust the waypoints for a plurality of skylanes such that a particular skylane has a more direct route to a destination to compensate for a delayed departure (e.g., due to a late arriving passenger).

The computing system can also activate (e.g., open) or deactivate (e.g., close) particular skylanes based on route assessments that evaluate skylane operating constraints relative to parameter data associated with nearby airspace. For example, consider an operating constraint for a particular skylane that includes a noise limit defining a threshold audible noise level established for the particular geographic area including the particular skylane. If current noise data for the particular skylane indicates that the noise level remains below the noise limit established by the operating constraint, then the particular skylane can remain open. If current noise data for the particular skylane indicates that the noise level exceeds the noise limit established by the operating constraint, then the particular skylane can be closed.

For skylanes having parameter data that violate or otherwise fail to satisfy operating constraints, that subset of skylanes can be deactivated or closed within the network of skylanes. Activation of a subset of skylanes can define that subset as available skylanes for eVTOL travel, while deactivation of a subset of skylanes can define that subset as unavailable skylanes for eVTOL travel. Skylane activation operations can be computed on a periodic basis such that the activation/deactivation can change as parameters are updated over time.

These and other aspects of the disclosed technology offer numerous technical effects and benefits, including but not limited to improved route planning, an improved framework for route selection, and an improved representation of skylanes in a planning network. For example, the improved route planning described herein, allows transportation network to achieve ultra-high aircraft throughput by properly organizing flows of air traffic into skylanes, which may be changed during real-time operation to accommodate changing demand patterns, weather, airspace restrictions, or other dynamic considerations.

The skylane network can be dynamically generated and updated using a combination of considerations that do not need to be known or reanalyzed for each new flight request. The considerations can include, for example, distance from origin to destination, noise sensitivity along a flight path, distance to a backup landing site, separation from traditional air traffic (e.g., arrival and departure flow at airports), and avoiding terminal airspace. This can help save computing resources by avoiding unnecessary processing rework, which can lead to latency during real-time operations.

Furthermore, a skylane network improves integration with air traffic control (ATC) by providing insight into intentions of aircraft using the network. Moreover, the skylane network can allow the ATC to determine if these aircraft are not in conformance, and simplifies aircraft tracking, trajectory prediction, intent inference, conflict detection and resolution, and other airspace services and functional requirements. This can lead to increased computational efficiency for ATC, allowing it to better focus its resources on its core functionalities.

The visualization of the skylane network can also improve operations of a transportation network. For instance, as described herein, the skylane network can be represented by a directed graph of nodes and edges. Nodes can correspond to various locations within a particular geographic area as well as waypoints along a skylane between locations. Directed edges can correspond to direction of travel between various nodes in the directed graph representation. The directed graph representation can be rendered on an interactive user interface that allows for waypoint manipulation through interaction with the directed graph. This configuration allows for more efficient route planning techniques such as shortest path determinations, or other travel path determination algorithms, as well as improved path adjustment in real-time. As such, an operator is able to more quickly approve a new skylane or skylane update leading to increased skylane deployment and usage.

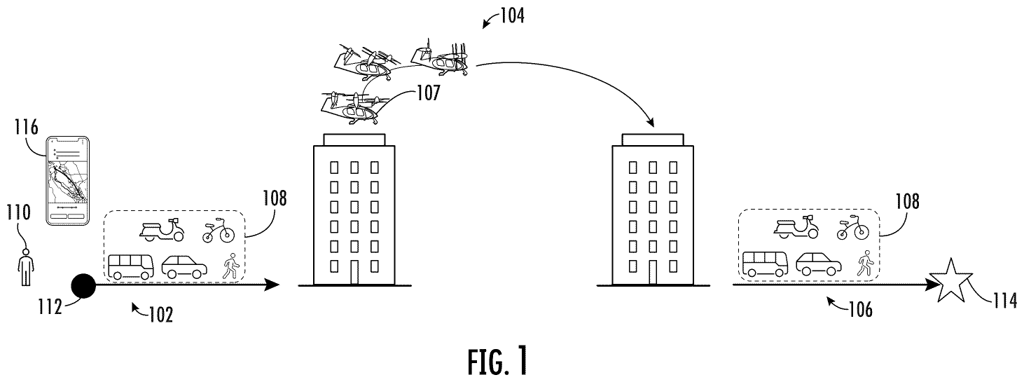

FIG. 1 depicts an example process flow of a multi-modal transportation service according to example implementations of the present disclosure. A multi-modal transportation service can include multiple transportation legs 102, 104, 106 associated with at least two different transportation modalities. For example, the multi-modal transportation service can include a first transportation leg 102, one or more second transportation legs 104, and a third transportation leg 106.

A combination of ground vehicles, aircraft, or other types of vehicles can perform the various legs of the multi-modal transportation service. Each transportation leg of the multi-modal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The multi-modal transportation service can be provided in an on-demand manner. The service can include a ridesharing, ride-hailing, or delivery service. The multi-modal transportation service can be coordinated for a user 110 by one or more service providers. A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for an itinerary for the journey for user 110. At least one option for the journey can include the multi-modal transportation service. Responsive to selection of the multi-modal transportation service option, the service can be initiated for transportation for user 110.

Building itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

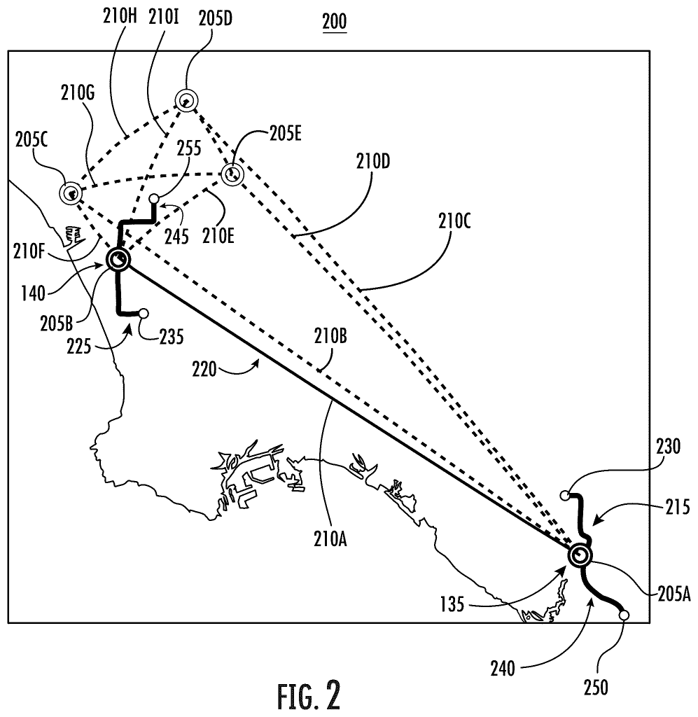

The itinerary of the user 120 can be based on the user's origin location, destination location, available intermediate locations for transitioning between transportation modalities, vehicle routes, and/or other information. For example, FIG. 2 depicts a graphical map diagram of an example multi-modal transportation service within a geographic area 200 according to example implementations of the present disclosure. The geographic area 200 can be, for example, an urban environment. The geographic area 200 can include a network of intermediate locations that can be used for transitioning a user from one transportation modality to another. For instance, the geographic area 200 can include a plurality of aerial facilities 205A-E. The aerial facilities 205A-E (e.g., vertiports) can allow a user to transition from a ground-based transportation modality to an aerial-based transportation modality, or vice versa. The plurality of aerial facilities 205A-E can be placed at various locations within the geographic area 200. The plurality of aerial facilities 205A-E can be connected by a plurality aerial routes 210A-J. In some implementations, the aerial routes 210A-J can be designed with respect to airspace constraints (e.g., noise constraints, air traffic constraints, etc.). In some implementations, demand modeling can be performed to select high value infrastructure locations for placing the plurality of aerial facilities 205A-E throughout the geographic area 200 and generating routes 210A-J between the aerial facilities 205A-E, without interfering with the airspace constraints. This network of aerial facilities 205A-E and routes 210A-J can be utilized to create flight plans for aircraft used within the multi-modal transportation service 100 to indicate how and where a particular aircraft may travel through an operational time period.

Multiple users can be pooled together for multi-modal transportation services, such that different user itineraries can share at least one transportation leg. This can include pooling users to share an intermediate transportation leg (e.g., a flight on an aircraft), even though the users may have different origin or destination locations.

By way of example, a first user itinerary for a first user can include three transportation legs 215, 220, and 225 (shown in bold in FIG. 2). The first user itinerary can include transporting the first user from a first origin location 230 to a first intermediate location (e.g., aerial facility 205A) to a second intermediate location (e.g., aerial facility 205B) and, ultimately, to a first destination location 235. The first and second intermediate locations can be determined based on their proximity (e.g., being the closest aerial facilities) to the first origin location 230 and the first destination location 235, respectively. The first user itinerary can include ground-based transportation modalities (e.g., cars, etc.) along the first and last transportation legs 215, 225 and an aerial-based transportation modality (e.g., VTOLs) along the intermediate transportation leg 220.

A second user itinerary for a second user can include three transportation legs 240, 220, and 245 (shown in bold in FIG. 2). The second user itinerary can include transporting the second user from a second origin location 250 to the first intermediate location (e.g., aerial facility 205A) to the second intermediate location (e.g., aerial facility 205B) and, ultimately, to a second destination location 255. The second user itinerary can include ground-based transportation modalities along the first and last transportation legs 240, 245 and an aerial-based transportation modality along the intermediate transportation leg 220.

The first user and the second user can be pooled together for the intermediate transportation leg 220. For example, the first user itinerary and the second user itinerary can respectively indicate that the first user and the second user are to travel in the same flight of an aircraft traveling along route 210A, to transport the users between aerial facility 205A and aerial facility 205B. In this manner, the first and second users can share at least one transportation leg for cost and power efficient multi-modal transportation.

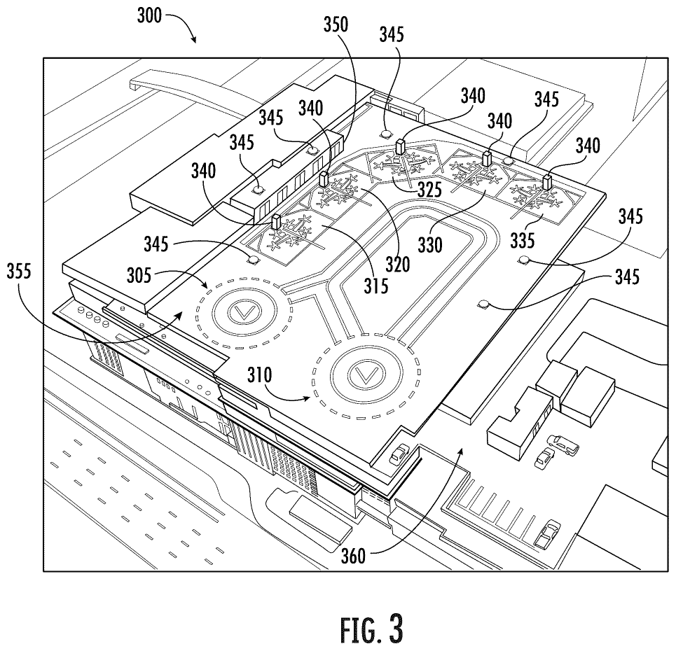

The intermediate locations within a multi-modal transportation service can be configured to help seamlessly transition users from one transportation leg or modality to another. As described herein, these intermediate locations can include aerial facilities for facilitating the takeoff (e.g., departure) and landing (e.g., arrival) of aircraft utilized in a multi-modal transportation service. By way of example, FIG. 3 depicts a graphical diagram of an example aerial facility 300 according to example implementations of the present disclosure. The aerial facility 300 can include a vertiport with one or more final approach and landing pads 305, 310 (e.g., FATO pads), one or more vehicle parking locations 315-335, or other infrastructure for maintaining and facilitating the functions of aircraft (e.g., VTOLs). Vertiport locations correspond to those portions of an aerial facility that are specifically designated for the aforementioned e VTOL operations, including but not limited to takeoff, landing, and parking operations. For example, the aerial facility 300 can include infrastructure 340 which can include hardware and software for refueling or recharging an aircraft between flights. Various portions of the infrastructure 340 can be accessible at one or more of the vehicle parking locations 315-335.

The aerial facility 300 can include a structure or area for transitioning a user to and from an aerial transportation leg of a multi-modal transportation service. The aerial facility 300 can be located in a geographic area where multi-modal transportation services are offered. For instance, the aerial facilities can include a building or designated area within a geographic environment. In some implementations, the aerial facility 300 can be a portion (e.g., a roof, dedicated floors, etc.) of a building or structure that may be used for other purposes (e.g., commercial, residential, industrial, parking, etc.).

The aerial facility 300 can include one or more sensors 345. The sensors can include visual, audio, or other types of sensors. For example, the sensors can include cameras, microphones, vibration sensors, motion sensors, RADAR sensors, LIDAR sensors, infrared sensors, temperature sensors, humidity sensors, other weather condition sensors, etc. The sensors 345 can be configured to obtain sensor data (e.g., noise data, weather data, aircraft-related data, etc.) within and around the aerial facility 300.

The aerial facility 300 can include one or more output devices. The output devices can include display screens, speakers, lighting elements, or other infrastructure to communicate information to users, facility operators, vehicle operators, or other individuals at the aerial facility 300. For example, display screens can be utilized to indicate an aircraft assigned to a user and a parking location assigned to an aircraft. The aerial facility 300 can include paths for users to travel to and/or from aircraft. In some implementations, the output devices (e.g., lighting elements) can help indicate the paths to the users.

The aerial facility 300 can include one or more access points 350 for user ingress and egress. The access points 350 can include designated areas, elevators, stairwells, etc. The access points 350 can also help users to transition between transportation legs and the different modalities associated therewith. For example, after being dropped-off at the aerial facility 300 by a ground-based vehicle for a first transportation leg, a user can utilize an access point 350 to enter an area 355 for checking-into a flight for the next transportation leg, an area for boarding an aircraft, etc. After unloading from the aircraft at the aerial facility 300, a user can utilize an access point 350 to access an area 360 for boarding a ground-based vehicle for a last transportation leg.

An aerial facility 300 can be operated by various entities. For example, a service entity that manages a fleet of aircraft and/or coordinates a transportation service can own, control, operate, etc. the aerial facility 300. In some implementations, the aerial facility 300 can be owned, controlled, operated, etc. by a third-party facility provider. The third-party facility provider may not have its own aircraft fleet but may operate the aerial facility 300 and/or permit other entities to utilize the aerial facility 300.

The aerial facility 300 can be utilized by a single entity or shared among a plurality of entities. For example, a service entity that manages/operates a fleet of aircraft can own, lease, control, operate, etc. the entire aerial facility 300. The service entity and its associated fleet may exclusively utilize the aerial facility 300, such that aircraft outside the service entity's fleet are not permitted at the aerial facility 300, except in emergency circumstances. In another example, a first service entity that manages/operates a first fleet of aircraft can share the aerial facility 300 with a second service entity that manages/operates a second fleet of aircraft. In some implementations, certain resources at the aerial facility 300 can be assigned to a particular fleet or service entity. For example, a first set of landing pads, parking pads, infrastructure, storage areas, waiting areas, etc. can be designated for the first service entity and its associated fleet. A second set of landing pads, parking pads, infrastructure, storage areas, waiting areas, etc. can be designated for the second service entity and its associated fleet. In some implementations, the resources at the aerial facility 300 can be shared such that the shared resources can be assigned dynamically, throughout an operational time period based on user/aircraft itineraries, charging needs, etc.

The aerial facility 300 can include an aerial facility computing system, not shown in FIG. 3. The aerial facility computing system can be configured to monitor and control the various resources of the aerial facility 300. This can include, for example, monitoring and controlling infrastructure such as chargers, sensors, output devices, etc. The aerial facility computing system can include one or more computing devices and can communicate with other computing systems and devices associated with the multi-modal transportation service.

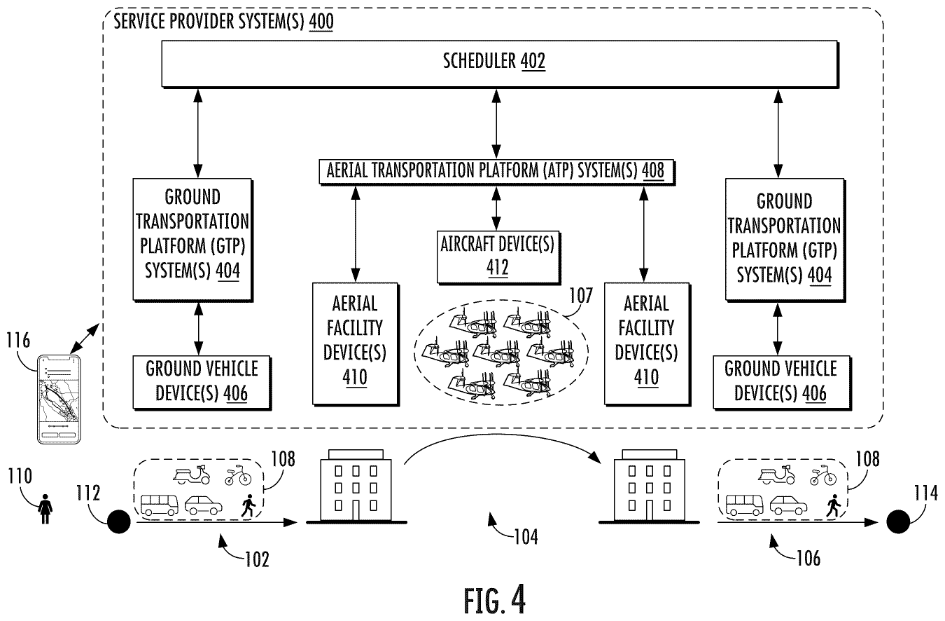

FIG. 4 is a block diagram illustrating systems and devices that can respectively correspond to the various modalities of transportation of an example multi-modal transportation service. User 110 can interact with software operating on user device 116 to communicate with one or more service provider systems 400 to request a transportation service. Service provider systems 400 can be associated with one or more service providers.

Service provider systems 400 can include a scheduler 402 that builds on-demand multi-modal itineraries. Scheduler 402 can communicate with ground transportation platform (GTP) systems 404 to allocate one or more ground vehicles (or other ground modalities), corresponding to one or more ground vehicle devices 406, for servicing the first leg 102. Scheduler 402 can communicate with aerial transportation platform (ATP) systems 408 to allocate an aerial facility, corresponding to one or more aerial facility devices 410, for transitioning user 110 from first leg 102 to second leg 104. Scheduler 402 can communicate with ATP systems 408 to allocate space on an aircraft 107, corresponding to one or more aircraft devices 412, for servicing the second leg 104. Scheduler 402 can communicate with ATP systems 408 to allocate another aerial facility, corresponding to one or more other aerial facility devices 410, for transitioning user 110 from second leg 104 to third leg 106. Scheduler 402 can communicate with GTP systems 404 to allocate a ground vehicle 108, corresponding to one or more ground vehicle devices 406, for servicing the third leg 106. The GTP systems 404 (and types of ground modalities) associated with first leg 102 can be the same as or different from the GTP systems 404 (and types of ground modalities) associated with third leg 106.

Scheduler 402 can be a back-end coordination layer that communicates with GTP systems 404 and ATP systems 408. Scheduler 402 can be implemented external to either one or both of GTP systems 404 and ATP systems 408, such as on its own server systems. Scheduler 402 can be implemented internally by either one or both of GTP systems 404 and ATP systems 408. For instance, a first system associated with a first type of transportation modality (e.g., ground transport) can be a primary orchestrator that compiles an itinerary using scheduler 402 to request, from a second system associated with a second type of transportation modality (e.g., aerial transport), availability data for assets associated with the second modality. User devices 116 can thus communicate with the first system to obtain a complete multi-modal itinerary.

In some implementations, GTP systems 404 can implement scheduler 402. User devices 116 can communicate with GTP systems 404 to request a transportation service for a journey. For instance, user devices 116 can execute an application associated with the GTP systems 404 (e.g., an application associated with a service entity that controls GTP systems 404). GTP systems 404 can request, from ATP systems 408, availability of aircraft for compiling, with scheduler 402, a multi-modal itinerary for providing the transportation service. User devices 116 can receive the proposed multi-modal itinerary from GTP systems 404. For instance, user devices 116 can view the proposed multi-modal itinerary in the application associated with the GTP systems 404.

In some implementations, ATP systems 408 can implement scheduler 402. User devices 116 can communicate with ATP systems 408 to request a transportation service for a journey. For instance, user devices 116 can execute an application associated with the ATP systems 408 (e.g., an application associated with a service entity that controls ATP systems 408). ATP systems 408 can request, from GTP systems 404, availability of ground vehicles (or walking instructions) for compiling, with scheduler 402, a multi-modal itinerary for providing the transportation service. User devices 116 can receive the proposed multi-modal itinerary from ATP systems 408. For instance, user devices 116 can view the proposed multi-modal itinerary in the application associated with the ATP systems 408.

In an example, the second system can be the primary orchestrator. The first system associated with a first type of transportation modality (e.g., ground transport) can request, from the second system associated with a second type of transportation modality (e.g., aerial transport), a transportation service that includes transportation along a leg of a multi-modal journey that uses the second type of transportation modality. The second system can compile a complete multi-modal itinerary that includes transportation along a leg of a multi-modal journey that uses the second type of transportation modality. The second system can communicate with the first system to schedule transportation services for one or more legs of the itinerary. The second system can then return one or more completed itineraries to the first system. User devices 116 can thus communicate with the first system to obtain a complete multi-modal itinerary.

For instance, user devices 116 can communicate with GTP systems 404 to request a transportation service for a journey. For instance, user devices 116 can execute an application associated with the GTP systems 404 (e.g., an application associated with a service entity that controls GTP systems 404). GTP systems 404 can request, from ATP systems 408, an aerial transportation service along a leg of the journey. ATP systems 408 can obtain availability data for its aircraft to service the requested leg. Based on the availability data, ATP systems 408 can request, from GTP systems 404, availability of ground vehicles (or walking instructions) for a transportation service along a leg preceding the aerial leg and along a leg succeeding the aerial leg. ATP systems 408 can, with scheduler 402, compile a multi-modal itinerary for providing the transportation service. ATP systems 408 can communicate the compiled itinerary to GTP systems 404. User devices 116 can receive the proposed multi-modal itinerary from GTP systems 404. For instance, user devices 116 can view the proposed multi-modal itinerary in the application associated with the GTP systems 404.

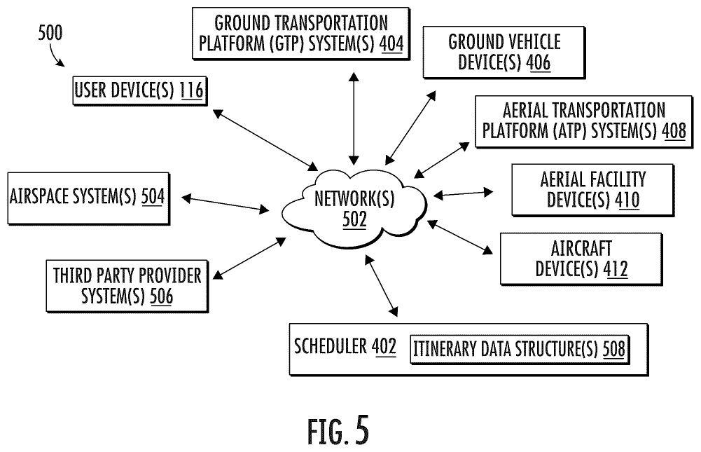

FIG. 5 is a block diagram illustrating an example networked ecosystem 500 for cross-platform coordination for multi-modal transportation services. Multiple network-connected systems can cooperatively interact with scheduler 402 over networks 502 to provide multi-modal transportation services. The one or more networks 502 can include networks associated with GTP systems 404, networks associated with ATP systems 408, networks associated with public or publicly used infrastructure (e.g., telecommunications networks), etc. One or more airspace systems 504 can also participate in networked ecosystem 500. One or more other third party provider systems 506 can also participate in networked ecosystem 500. Responsive to communications from user devices 116, and based on communications with participating systems of the networked ecosystem 500, scheduler 402 can generate itinerary data structures 508 that describe allocations of one or more assets from GTP systems 404 and ATP systems 408, as further described herein.

User devices 116 can include computing devices owned or otherwise accessible to a user of a transportation service. For example, a user device 116 can include a hand-held computing device (e.g., a phone, a tablet, etc.), a wearable computing device (e.g., smart watch, smart glasses, etc.), personal desktop devices, or other devices. User devices 116 can execute one or more instructions to run an instance of a software application for a respective transportation platform and present user interfaces associated therewith. User devices 116 can include personal devices (e.g., a mobile device) or shared devices on which a user has initiated a personal session (e.g., by logging into a public kiosk or display device in a vehicle, etc.).

As described herein, GTP systems 404 can be associated with a service entity that provides a ground transportation service. GTP systems 404 can include a computing platform (e.g., a cloud services platform, server system, etc.) communicatively connected over networks 502 to one or more of the systems or devices of networked ecosystem 500.

GTP systems 404 can include or implement one or more client-facing software applications accessible to the devices of networked ecosystem 500. Users can interact with the GTP systems 404 (e.g., using user devices 116, ground vehicle devices 406, aircraft devices 412) to receive various types of transportation services (e.g., delivery, ridesharing, or ride-hailing, etc.) including the multi-modal transportation services described herein. For example, a GTP system 404 can match one of its associated ground vehicles or operators with users for a ground transportation service.

GTP systems 404 can be associated with ground infrastructure for facilitating the performance of a ground transportation service. The ground infrastructure can include one or more parking areas, vehicle transfer hubs, charging/fueling locations, storage facilities, etc.

GTP systems 404 can be associated with a fleet of ground vehicles (e.g., cars) and the vehicle operators can include a network of ground vehicle operators. The network of ground vehicle operators can include drivers or remote operators that facilitate, oversee, or control the movement of ground vehicles available to perform ground transportation services.

Ground vehicle devices 406 can include computing devices or systems associated with a ground vehicle or operator. For example, ground vehicle devices 406 can include one or more vehicle computing systems such as, for example, an onboard computer for operating the vehicle, an autonomy system, an infotainment system, etc. Additionally, or alternatively, ground vehicle devices 406 can include an operator's user device (e.g., a driver's mobile phone, etc.). In some implementations, ground vehicle devices 406 can include a user device that remains onboard a ground vehicle such as, for example, a tablet that is available to a passenger or operator.

ATP systems 408 can be associated with one or more service entities that provide at least an aerial transportation service to users. ATP system 408 can include a computing platform (e.g., a cloud services platform, server system, etc.) communicatively connected over networks 502 to one or more of the systems or devices of networked ecosystem 500.

ATP systems 408 can include or implement one or more client-facing software applications accessible to the devices of networked ecosystem 500. Users can interact with ATP system 408 (e.g., using user devices 116, ground vehicle devices 406, aircraft devices 412) to receive various types of information related to a transportation service. For example, a user (e.g., a rider) can interact an ATP system 408 via an instance of a software application (e.g., a rider app) running on user device 116 to request and book a multi-modal transportation service. A facility operator can interact with an ATP system 408 via an instance of a software application (e.g., an operations app) running on an aerial facility device 410 (e.g., a facility operator user device) to view/adjust flight information, seat assignments, etc.

ATP systems 408 can be associated with one or more aircraft, aircraft operators, aerial facilities (or portions thereof), facility operators, etc. for facilitating the performance of at least an aerial transportation service. For example, the aircraft can include a fleet of aircraft and the vehicle operators can include a network of aircraft operators. The network of aircraft operators can include pilots or remote operators that facilitate, oversee, or control the movement of aircraft available to perform aerial transportation services.

Aerial facilities used for providing a transportation service can include one or more aerial facility devices 410 or one or more facility operators. Aerial facility devices 410 can be positioned at various locations within or around the aerial facility to collect and receive information associated with an aerial transportation service. Aerial facility devices 410 can include one or more charging devices associated with charging infrastructure of the aerial facility, one or more vehicle positioning devices (e.g., motorized tugs, etc.), one or more sensors or surveillance devices (e.g., noise sensors, cameras, etc.), etc. Facility operators can be associated with an aerial facility to assist users with security checks, check-ins, boarding/de-boarding, performing aircraft checks, etc. Aerial facility devices 410 can include facility operator user devices, such as user devices used by the facility operators. Facility operator user devices can be used to communicate with a transportation platform or perform various functions at an aerial facility. For example, facility operator user devices can run one or more software applications to complete security checks, check in/out luggage, coordinate re-charging/re-fueling, present safety briefings, or the like.

Aircraft devices 412 can include one or more aircraft computing systems or aircraft operator user devices. For instance, aircraft devices 412 can include a computing system onboard an aircraft such as a pilot interface, an avionics system, an infotainment system, a navigation system, an autonomy system, or any other sensors or devices located on an aircraft and capable of sending or receiving information. Aircraft devices 412 can include an aircraft operator's user device (e.g., a pilot's mobile phone). Aircraft devices 412 can include a user device that remains onboard the aircraft such as, for example, a tablet or display that is available to a passenger or operator.

Airspace systems 504 can include one or more airspace data exchanges or otherwise be associated with regulatory bodies configured to collect real-time, historical, or regulatory airspace data. The airspace systems 504 can include, for example: (i) aggregating systems that pool airspace data associated with an airspace; (ii) third-party monitoring systems configured to monitor aspects of an airspace (e.g., noise, etc.); or (iii) regulatory systems that can confirm, validate, or approve an aerial transportation service before takeoff based on one or more policies or standards set by a regulatory body (e.g., Federal Aviation Administration, European Aviation Safety Agency, etc.).

Third-party provider systems 506 can be associated with one or more third parties that provide resources to ATP systems 408 or GTP systems 404. Third-party provider systems 506 can be associated with a third-party aircraft provider, including one or more “third-party” aircraft or one or more third-party aircraft operators. Third party aircraft can include aircraft provided, leased, loaned, or otherwise made available by an entity for use by ATP systems 408 for transportation services. Third-party aircraft operators can include, for example, a plurality of aircraft pilots that may be available to ATP systems 408 for operation of an aircraft for the transportation services.

In some implementations, third-party provider systems 506 can be associated with a third-party facility provider that can provide facilities (or facility resources) for use in performing transportation services. For example, the third-party facility provider can own, operate, etc. one or more aerial facilities (or portions thereof) that can be rented, leased, or otherwise utilized by a transportation platform system for providing an aerial transportation service. ATP system 408 or the GTP system 404 can communicate directly or indirectly (e.g., through the third-party provider systems 506) with the third-party aircrafts, operators, or infrastructure.

To facilitate an on-demand multi-modal transportation service for a particular service request associated with user devices 116, scheduler 402 can generate itinerary data structures 508. As illustrated in FIGS. 1-5, facilitating an on-demand multi-modal transportation service can involve complex coordination between multiple different systems and devices for allocating respective resources of each system for performing various tasks associated with the on-demand multi-modal transportation service. Itinerary data structures 508 can describe allocations of the respective resources from participants in networked ecosystem 500.

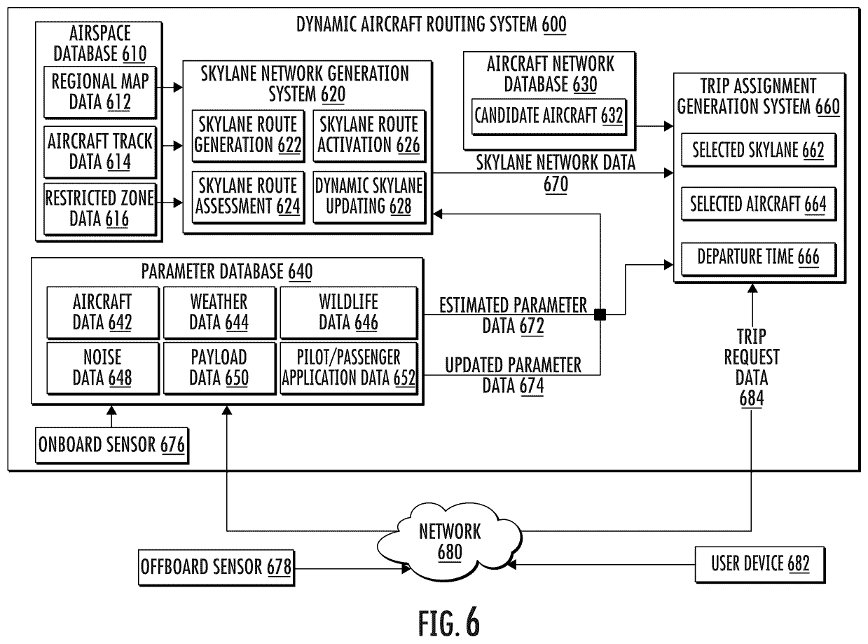

FIG. 6 depicts a block diagram of an example dynamic aircraft routing system 600 according to example implementations of the present disclosure. Dynamic aircraft routing system 600 can include an airspace database 610, a skylane network generation system 620, an aircraft network database 630, a parameter database 640, and a trip assignment generation system 660. In one implementation, dynamic aircraft routing system 600 can be included within or distributed across one or more of an aerial transportation platform (ATP) system 408, a ground transportation platform (GTP) system 404, a third party provider system 506, an aerial facility device 410, such as those depicted in FIG. 5, or other computing platform systems associated with an aviation transport network.

Aspects of dynamic aircraft routing system 600 are described herein as pertaining to a particular geographic area. Such particular geographic area can include a comprehensive geographic area associated with aviation transport or a smaller subset of such a geographic area. A particular geographic area analyzed by dynamic aircraft routing system 600 can include a country, state, county, city, town, or other municipality, a portion of a grid overlayed on a geographic area (e.g., a square mile, a square kilometer, or other portion of an area), a portion of an area defined with a point of interest as the center (e.g., a geographic area having a particular radius defined to surround a particular vertiport for operation of eVTOL aircraft). Although some examples of geographic areas are depicted herein, the subject systems and methods can apply to other particular geographic areas.

Airspace database 610 can include one or more portions of data associated with the airspace of a particular geographic area in which eVTOL aircraft can be configured to travel. In one implementation, airspace database 610 is included within dynamic aircraft routing system 600. In another implementation, the data stored within airspace database 610 is stored remotely from dynamic aircraft routing system 600 and can be accessed over one or more wired or wireless communication networks, such as network 680.

Airspace data stored in airspace database 610 can include, for example, regional map data 612, aircraft track data 614, and restricted zone data 616. Airspace data stored in airspace database 610 can be configured to define one or more available portions of a particular geographic area for eVTOL aircraft travel. In some implementations, available portions of a particular geographic area suitable for eVTOL aircraft travel can be computed based on where a first type of other aircraft have previously flown within the airspace of a particular geographic area. In some implementations, available portions of a particular geographic area suitable for eVTOL travel can be computed based on where a second type of other aircraft have previously flown within the airspace of a particular geographic area.

Regional map data 612 can include high-definition (HD) map data for use by the dynamic aircraft routing system or other aspects of the subject aviation transport network. For example, regional map data 612 can include customized maps created for purposes of aviation transport by a first-party or third-party fleet of aircraft (e.g., eVTOL aircraft). In other examples, regional map data 612 can include publicly available map data accessed for purposes of skylane generation and updating in accordance with the disclosed techniques. Regional map data 612 can include data in the form of ground charts and/or aeronautical charts. Regional map data 612 can include one or more layers of feature data, image data, raster data, and/or vector data provided in a variety of suitable file formats including but not limited to CSV, TSV, KML, KMZ, ESRI, TIFF, GPX, and/or XLSX files or other file formats suitable for interfacing with Geographic Information Systems (GIS) applications. In some implementations, regional map data 612 can be accessed by skylane network generation system 620 for computational processing to generate and/or update skylanes within a network of skylanes.

Regional map data 612 can further include landmark data associated with landmarks within a particular geographic area. Landmarks identified within the regional map data 612 may correspond to an object or feature of a landscape or region that is easily seen and recognizable from a distance. Landmarks and associated data can be especially useful for eVTOL pilots to establish their location by way of visual reference relative to one or more landmarks. Landmark data stored within regional map data 612 can include one or more categories of identifying information including, but not limited to, landmark name, landmark location, landmark parameters, and/or landmark designations (e.g., permissions or restrictions) for various skylane routing and travel.

The landmark data within regional map data 612 can be processed as part of dynamically determining and/or updating skylanes as described herein. Landmarks can be selectively activated and/or deactivated for use as waypoints or other locations along a skylane. For example, a landmark such as the White House in Washington, D.C. may be associated with a flight restriction such that it cannot be set as a skylane waypoint or part of an activated skylane for travel. In another example, landmarks such as the Statue of Liberty or the Hudson River in New York are readily identifiable in that geographic area and can enhance visual flight readiness while traversing skylanes near such landmarks. Such landmarks may be associated with a landmark designation (e.g., permission) that permits selection of the landmark as a waypoint or other point for incorporation in a dynamically generated or currently activated skylane. As such, skylane network generation system 620 can compute skylane route data for a particular skylane by determining waypoints in three-dimensional space relative to the landmark data or other data provided within regional map data 612.

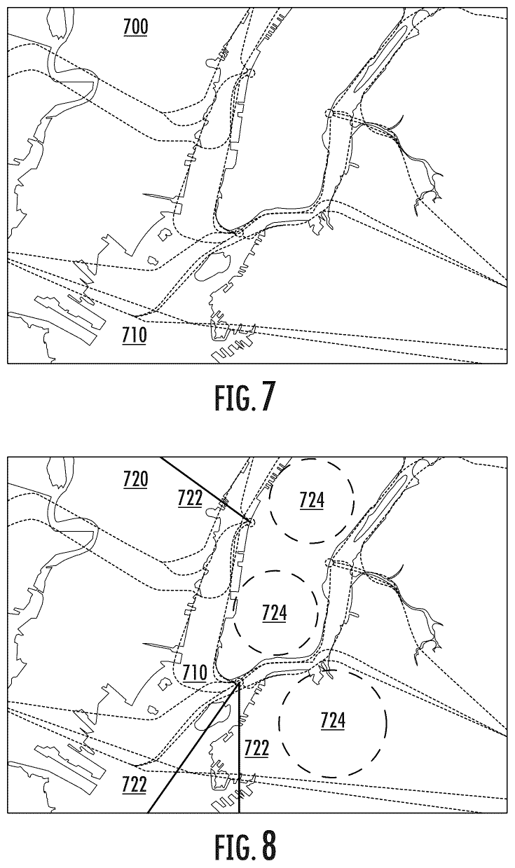

Aircraft track data 614 can include geographic or map-based data indicative of locations traveled by an aircraft in a particular geographic area. Aircraft track data 614 can thus correspond to historical data indicative of previous routes flown that are repurposed in a unique manner as described herein. An example of aircraft track data 614 is depicted in FIG. 7, which shows aircraft track data 614 overlayed on map data 700 for a particular geographic area. Although aircraft track data 614 in FIG. 7 appears two-dimensional, it should be appreciated that aircraft track data 614 can include three-dimensional locations defined in terms of three coordinates (e.g., longitude, latitude, and altitude).

Aircraft track data 614 can correspond to locations traveled by an aircraft in the particular geographic area within a particular time or range of time (e.g., in a given hour, a given day, a given week, etc.). Aircraft track data 614 can correspond to locations traveled by a particular type of aircraft. For instance, aircraft track data 614 can correspond to locations traveled by a same type of aircraft (e.g., eVTOL) for which skylanes are generated and updated as described herein. In other instances, aircraft track data 614 can correspond to locations traveled by a type of aircraft having operational parameters in a particular range (e.g., aircraft configured for travel at airspeeds of less than about 300 knots (e.g., between 100 knots and 200 knots). This particular range may include rotary-wing aircraft and some smaller/slower fixed wing aircraft (e.g., propeller planes) but exclude larger/faster fixed-wing aircraft such as turbo props and/or jets. Utilizing aircraft track data 614 for aircraft that have at least some degree of similarity to eVTOL aircraft can help to identify potential suitable corridors for eVTOL aircraft travel within the particular geographic area. As such, skylane network generation system 620 can compute skylane route data for a particular skylane by determining waypoints in three-dimensional space relative to the aircraft track data 614.

Restricted zone data 616 can include geographic or map-based data indicative of portions of a particular geographic area that are unavailable for eVTOL travel. As such, skylane network generation system 620 can compute skylane route data for a particular skylane by determining waypoints in three-dimensional space relative to the restricted zone data 616.

Restricted zone data 616 can include location data associated with takeoff and landing paths for other aircraft operating in the particular geographic area. The other aircraft associated with takeoff and landing paths within restricted zone data 616 can correspond to a different type of aircraft than eVTOL aircraft. For example, restricted zone data 616 can include location data associated with takeoff and landing paths for a type of aircraft having operational parameters in a particular range (e.g., aircraft configured for travel at airspeeds of greater than about 300 knots). This particular range may include larger/faster fixed-wing aircraft such as turbo props and/or jets but exclude eVTOL aircraft, rotary-wing aircraft and some smaller/slower fixed-wing aircraft such as propeller planes. An example of restricted zone data 616 corresponding to location data associated with takeoff and landing paths for other aircraft operating in the particular geographic area is depicted as takeoff and landing paths 722 in FIG. 8.

Restricted zone data 616 can additionally or alternatively include location data associated with a no-fly zone designated by a regulating body of the airspace within the particular geographic area (e.g., Federal Aviation Administration (FAA), European Aviation Safety Agency, etc.). Restricted zone data 616 can identify excluded airspace location data defined by other types of Notices to Airmen (NOTAM) including a Temporary Flight Restriction (TFR) or other data defining a geographic area restricted to air travel due to a hazardous condition, special event, or other airspace restriction. An example of restricted zone data 616 corresponding to no-fly zones is geographically depicted in FIG. 8 as no-fly zones 724.

In some implementations, additional airspace data stored within airspace database 610 can include information provided by the airspace systems 420. The airspace systems 420 can include one or more airspace data exchanges or otherwise be associated with regulatory bodies configured to collect real-time, historical, or regulatory airspace data. The airspace data can include information regarding the weather, air-traffic, or regulatory approval for flight operations in an airspace. The airspace systems 420 can include, for example: (i) aggregating systems that pool airspace data associated with an airspace; (ii) third-party monitoring systems configured to monitor aspects of an airspace (e.g., noise, etc.); and/or (iii) regulatory systems that can confirm, validate, or approve an aerial-based transportation service before takeoff based on one or more policies or standards set by a regulatory body (e.g., Federal Aviation Administration, European Aviation Safety Agency, etc.).

Additional airspace data provided by the airspace systems 420 or otherwise included within airspace database 610 can include real-time airport or vertiport configuration data. Airports can select among different possible configurations for incoming and outgoing flight traffic at different days and different times. As such, access to real-time airport configuration data can be important to dynamic determination and updating of skylanes within a given geographic area associated with other airports and/or vertiports. As such, skylane network generation system 620 can generate and/or activate skylane route data for a particular skylane based at least in part on a determination that the skylane (or waypoints, segments, or portions thereof) do not interfere with airspace currently occupied by incoming or outgoing air traffic based on a particular airport configuration as identified within the airspace database 610.

Referring still to FIG. 6, skylane network generation system 620 can include one or more systems configured to implement dynamic skylane determination and updating. For example, skylane network generation system 620 can include skylane route generation system 622, skylane route assessment system 624, skylane route activation system 626, and dynamic skylane updating system 628.

Skylane route generation system 622 can be configured to generate a network of skylanes for eVTOL aircraft travel in the particular geographic area. For example, skylane route generation system 622 can be configured to compute skylane route data for a particular skylane (e.g., a new skylane) within the network of skylanes based at least in part on the airspace data accessed from airspace database 610. Additional aspects of computing the skylane route data for a particular skylane are described herein with reference to FIGS. 7A-7D, 8A-8B, and 10-13.

The generation of a new skylane can be triggered due to the detection of one or more initiating events by skylane route generation system 622. For example, skylane route generation system 622 can detect an initiating event corresponding to the designation of a new vertiport for eVTOL aircraft operation. New vertiports can correspond, for example, to one of the aerial facilities 205A-E depicted in FIG. 2. In such instance, dynamic aircraft routing system 600 can access vertiport data from a remote computing platform. Vertiport data can be accessed, for example, from aerial transportation platform (ATP) system 405 of FIG. 4. The vertiport data can be compared to a list of previously known vertiports to detect new vertiports. Alternatively, new vertiports can be detected based on vertiport identifiers submitted in a request for the skylane route generation system to determine a new skylane for the new vertiport. Skylane route data for a new skylane can then be determined from a first vertiport location associated with the new vertiport to a second vertiport location within the particular geographic area that can be serviced from the first vertiport location of the new vertiport.

Additionally, or alternatively, skylane route generation system 622 can detect an initiating event corresponding to a request for a new skylane relative to an existing vertiport within the eVTOL transport network. A new skylane may be needed to address changing operation of the eVTOL transport network. For instance, a new skylane may be needed to accommodate an increased volume of trip requests relative to the existing vertiport, a decommissioning of an existing skylane (e.g., for failure to satisfy operating constraints associated with the existing skylane), an updated configuration of a nearby airport, an updated availability of parameter data, etc. The request for a new skylane relative to an existing vertiport can be initiated automatically based on route assessments computed by the skylane route assessment system 624, or can be initiated based on a manual request for new skylanes from an entity, such as but not limited to an aircraft provider or aerial facility operator. Skylane route data for a new skylane can then be determined from a first vertiport location associated with the existing vertiport to a second vertiport location within the particular geographic area that can be serviced from the first vertiport location of the existing vertiport.

Still further, skylane route generation system 622 can detect an initiating event corresponding to a trip request for transport of passengers and/or goods within a particular geographic area. For example, trip request data 684 from a user device 682 (or from another entity such as a service provider of ground and/or aerial vehicles) can include a first vertiport location and a second vertiport location between which aerial transport is requested. In response to receipt of the trip request data 684, skylane route generation system 622 can be triggered to generate skylane route data for a new skylane between the first vertiport location and the second vertiport location.

In response to detecting one or more of the initiating events, skylane route generation system 622 can be configured to send a request to the airspace database 610 to access airspace data defining an available portion of the particular geographic area for the eVTOL travel. For example, the skylane route generation system 622 can request access to regional map data 612, aircraft track data 614, and/or restricted zone data 616. Based on the airspace data accessed from airspace database 610, skylane route generation system 622 can be configured to compute skylane route data for a particular skylane defined by a plurality of waypoints in three-dimensional space between a first vertiport location and a second vertiport location for the eVTOL aircraft in the particular geographic area. In some implementations, computing skylane route data for a particular skylane can include computing first skylane route data and second skylane route data. The first skylane route data can define a first plurality of waypoints for travel in a first direction from the first vertiport location to the second vertiport location. The second skylane route data can define a second plurality of waypoints for travel in a second direction from the second vertiport location to the first vertiport location.

In some implementations, the skylane route data for the particular skylane also includes a plurality of altitude profiles associated with the plurality of waypoints in three-dimensional space. For example, skylane route data can include fixed waypoints in latitudinal and longitudinal dimensions and a plurality of altitude profiles from which to select among. The plurality of altitude profiles can include, for example, a first altitude profile at a first altitude, a second altitude profile at a second altitude that is different than the second altitude, a third altitude that is different than the first altitude and the second altitude, etc.

Skylane route data for a particular skylane can additionally or alternatively include an operational volume defining a three-dimensional corridor of airspace around a route associated with the particular skylane between the first vertiport location and the second vertiport location. The operational volume represents a piece (or segment) of airspace that surrounds a flight path, route, or trajectory. In one example, an operational volume is a three-dimensional representation of the skylane between two locations (e.g., first vertiport location and second vertiport location). In other examples, the operational volume is defined by the four-dimensional coordinates of its sectional geometry. The types of geometry include, for example, a polygon with a rectangular section having eight vertices (e.g., four on a bottom section and four on a top section) and a tube with a circular section defined by a radius and a length of the tube.

Different types of geometry can be used for different types of aircraft and/or based on the preference of an entity associated with the aircraft (e.g., vendor, manager, manufacturer, third-party operator). In some examples, a vehicle (e.g., aircraft) configuration performance can be taken into consideration to define an operational volume. For example, if the aircraft flies vertically (e.g., a VTOL), it may not need as large of volume to fly in as other types of aircraft. As such, the volume can be reduced around the configuration performance since the aircraft is good at climbing vertically. As such, the operational volume generation process can build static volume around routes but can also create volumes that are appropriate around aircraft type to match its profile instead of being bigger to encompass more possibilities.

Skylane route data for a particular skylane can additionally or alternatively include a directed graph representation of nodes and edges, the first vertiport location and the second vertiport location corresponding to nodes within the directed graph representation. In some implementations, the waypoints between the first vertiport location and the second vertiport location also correspond to nodes within the directed graph representation. Waypoints can correspond to landmarks or other intermediate geographic locations between respective vertiport locations. In this way, segments of skylanes defined between waypoints can be generated and/or subsequently evaluated and/or updated such that portions of skylanes can be advantageously analyzed on a more granular level. The directed edges between nodes in the directed graph representation (e.g., nodes corresponding to first and second respective vertiport locations) can include, for example, a first directed edge corresponding to a first direction of travel from the first vertiport location to the second vertiport location and a second directed edge corresponding to a second direction of travel from the second vertiport location to the first vertiport location.

Skylane route data for a particular skylane can additionally or alternatively include one or more operating constraints associated with the particular skylane. For instance, an operating constraint associated with respective skylanes of a skylane network can include a type of eVTOL aircraft designated for travel on the respective skylanes. In another example, an operating constraint associated with respective skylanes can include a speed for eVTOL aircraft designated for travel on the respective skylanes. In yet another example, an operating constraint associated with respective skylanes can include a noise limit defining a threshold visual noise level or a threshold audible noise level established for the particular geographic area. Still further, an operating constraint associated with respective skylanes can include a weather condition limit defining an acceptable level of a temperature, a pressure, a wind condition, or a visibility condition established for the particular geographic area. Operating constraints associated with particular skylanes can be defined in terms of one or more ranges of acceptable values or one or more threshold values (e.g., a minimum threshold value a parameter must be greater than or a maximum threshold value a parameter must be less than). Operating constraints associated with particular skylanes can be stored in the form of metadata defining the operating constraint saved in conjunction with skylane route data for the particular skylanes in the skylane network.

After new skylanes are computed by skylane route generation system 622, the skylane route generation system 622 can be configured to process the new skylanes in accordance with one or more quality analysis computations. For example, skylane route generation system 622 can be configured to implement a flight simulation of a simulated e VTOL aircraft traveling on the particular skylane. If the automated flight simulation is successful, then a newly generated skylane can be added to a skylane network. In some instances, the automated flight simulation may identify one or more updates to the newly generated skylane that must be made before being retested and potentially later added to the skylane network.

Referring still to FIG. 6, parameter database 640 can include one or more portions of data associated with the operating environment of a particular geographic area in which eVTOL aircraft can be configured to travel. In one implementation, parameter database 640 is included within dynamic aircraft routing system 600. In another implementation, the data depicted as part of parameter database 640 is stored remotely from dynamic aircraft routing system 600 and can be accessed over one or more wired or wireless communication networks, such as network 680. Parameter data stored in parameter database 640 can include, for example, aircraft data 642, weather data 644, wildlife data 646, noise data 648, payload data 650, and pilot/passenger application data 652.

Parameter data stored in parameter database 640 can be obtained in different fashions. For example, parameter data can be gathered periodically in a variety of manners. For instance, parameter data can be actively provided or passively requested from sensors or other databases at particular intervals (e.g., daily, hourly, every minute, every second, or even every fraction of a second). Some or all parameter data in parameter database 640 can include a timestamp that indicates the time at which the parameter data was acquired, location data (e.g., GPS coordinates) that indicates a location at which the parameter data was acquired, and/or fidelity data descriptive of an accuracy level associated with the parameter data.

Parameter data in parameter database 640 can be computed based on information from one or more onboard sensors 676 and/or one or more offboard sensors 678. As shown in FIG. 6, onboard sensor 676 may correspond to a sensor onboard an aircraft or onboard the dynamic aircraft routing system 600 while offboard sensor 678 may correspond to a sensor offboard an aircraft or offboard the dynamic aircraft routing system 600 and coupled to the aircraft or dynamic aircraft routing system 600 by network 680. In a particular example, a first offboard sensor is at location D and a second offboard sensor is at location E, where location D is the first (e.g., starting) vertiport location and location E is the second (e.g., ending) vertiport location.

The network 680 can be any type of network or combination of networks that allows for communication between devices. In some implementations, the network 680 can include one or more of a local area network, wide area network, the Internet, secure network, cellular network, mesh network, peer-to-peer communication link and/or some combination thereof and can include any number of wired or wireless links. Communication over the network 680 can be accomplished, for instance, via a network interface using any type of protocol, protection scheme, encoding, format, packaging, etc.

Aircraft data 642 can be provided by individual aircraft at particular time points, such as when an aircraft comes online and is ready to provide vehicle services. Aircraft data 642 can additionally or alternatively be provided by individual aircraft in response to periodically transmitted requests for information sent to aircraft by the dynamic aircraft routing system 600. Aircraft data 642 can include identification and status information associated with aircraft operating in the particular geographic area (e.g., eVTOL aircraft in a particular fleet or airspace). Aircraft data 642 can be provided by individual aircraft at particular time points, such as when an aircraft comes online and is ready to provide vehicle services. Aircraft data 642 can additionally or alternatively be provided by individual aircraft in response to periodically transmitted requests for information sent to aircraft by the dynamic aircraft routing system 600. Aircraft data 642 can include a unique vehicle identification (VID) and/or data indicative of the vehicle type, vehicle gross weight, aircraft configuration data including seating capacity and seating arrangement, vehicle battery capacity, and/or operator information. Aircraft data 642 can also include aircraft state information including the current charge level, the maintenance status and/or health condition of the VTOL aircraft, and the distance to the next service or maintenance event. In some examples, aircraft data 642 can include location parameter data defining takeoff and landing paths for other aircraft operating in the particular geographic area, similar to aircraft track data 614 for other aircraft that are a different type than the eVTOL aircraft. Aircraft data 642 can alternatively include runway use data indicative of current runways in use at an aircraft facility for aircraft operating within the particular geographic area.

Weather data 644 can include data defining a temperature, a pressure, a wind condition, or a visibility condition associated with the particular geographic area. In general, weather data 644 can characterize the weather and microclimates around vertiports. This may assist with safe and efficient aircraft (e.g., eVTOL) operation. In dense urban environments, a sudden change in weather conditions can result in wind conditions which may significantly alter the way aircraft land and depart from vertiports. In one embodiment, weather data 644 can be gathered via temperature, barometric, LIDAR (moisture monitoring), and radar data (S or X band). Changes in weather may additionally or alternatively be indirectly calculated based on perceived changes in IR or multispectral data from aircraft. This indirect delta may take into account the aircraft's routing history, age, and temporal effects. Weather data 644 can included monitored ground effect and gusts at final approaches and take offs (FATOs) and touchdowns and liftoffs (TLOFs). Using sensors to characterize velocity and pressure fields close to the ground plane can then be compared to predictive characterizations of the vertiport may help schedule vehicle takeoffs and landings and reduce the likelihood of performance challenges.

Wildlife data 646 can include data from one or more of multispectral sensors, IR, radar, cameras, and microphones to sense ground and air wildlife. The synthesis of sensor data from more than one source may assist in the correct identification of the type of wildlife and determine a proper response. Real-time presence of wildlife and/or determinations of historical trends of wildlife presence in particular portions of airspace can help shape the generation of skylanes and/or activation of particular skylanes for a particular timeframe. Use of wildlife data 646 in skylane generation, assessment, and or selection can help reduce the likelihood of aircraft, sensing, and infrastructure assets being negatively affected by direct or indirect effects of wildlife proximity, such as habitation or waste.

Noise data 648 can include data descriptive of an aircraft's noise signature and/or perceived noise impact from a particular ground location (e.g., vertiport location) within a particular geographic area. Noise data 648 can be descriptive of audible noise such as determined by microphones or other acoustic sensors. Noise data 648 can be additionally or alternatively descriptive of visual noise such as determined by cameras, LIDAR sensors, or other image-based sensors. Noise data 648 can be collected and aggregated by multiple onboard and/or offboard sensors, which can be affixed to ground based infrastructure (e.g., at vertiports), ground vehicles, air vehicles, and/or user devices (e.g., smartphones). At any given time, a data collection radius around a vertiport may be defined to determine which sensors to use for data collection relevant to the vertiport. In the case of noise collectors (e.g., microphones), the sensors may receive a signal to turn on (if not already on) and then begin collecting noise data 648. This data may be processed onboard the collector initially to filter out irrelevant or irregular noise patterns before sending to the parameter database 640. At the network level, additional processing may occur to generate a location-based noise or perception map which can then be made available to the vertiport to help with operational or airspace related decision-making.

Payload data 650 can include another type of aircraft data descriptive of one or more payload constraints and/or payload tracking associated with respective aircraft. For example, the payload data 650 can include at least one of a payload capacity (e.g., maximum allowable payload, weight, etc.), a seating capacity (e.g., a maximum number of passengers per flight), one or more vehicle control parameters (e.g., operational capabilities such as turning radius, lift, thrust, or drag capabilities), one or more speed parameters (e.g., maximum, minimum, or average speed, etc.), of respective aircraft. Payload data 650 can include payload tracking in the form of payload estimates for flights and/or actual sensor-obtained payload measurements for pilots, passengers, and or luggage or other goods transported by respective aircraft.

Pilot/passenger application data 652 can include data obtained by pilots and/or passengers that have an aviation transport application on a user device operated by such respective users. For example, pilot/passenger application data 652 can include location data from an application associated with a pilot or a passenger currently traveling on a particular skylane of the plurality of skylanes. The pilot/passenger application data 652 can include location data that can be used as an alternative to or addition to location data provided within aircraft data 642.

Referring still to FIG. 6, skylane network generation system 620 can be configured to access parameter database 640 and periodically obtain parameter data therefrom. Multiple systems of the skylane network generation system 620 can be configured to utilize the parameter data from parameter database 640, such as for example, in the skylane route generation system 622, skylane route assessment system 624, and dynamic skylane updating system 628.

In the context of skylane route generation system 622, skylane route data for a new skylane can be computed based at least in part on parameter data from parameter database 640. For example, a plurality of waypoints in three-dimensional space between a first vertiport location and a second vertiport location can be computed to define a skylane for an eVTOL aircraft in the particular geographic area, wherein the skylane route data for the particular skylane is computed based at least in part on the parameter data. For instance, noise data 648 can be accessed by the skylane route generation system 622. Skylane route data for a new skylane can be computed based on the noise data 648 to ensure that a new skylane is generated in an area that does not already approach a noise limit based on current noise data measurements or predictions. In another example, wildlife data 646 can be accessed by the skylane route generation system 622. Skylane route data for a new skylane can be computed based on the wildlife data to ensure that a new skylane is generated in an area that does not include a significant regular presence of wildlife (e.g., a migratory bird corridor) that may interfere with aircraft operation.

In the context of skylane route assessment system 624, respective skylanes can be evaluated relative to one more operating constraints of the respective skylanes. For example, skylane route assessment system 624 can be configured to access skylane network data stored within skylane route generation system 622, including data defining an operating constraint associated with respective skylanes in a network of skylanes.

Skylane route assessment system 624 can also access parameter data from parameter database 640. The parameter data accessed by skylane route assessment system 624 can include estimated parameter data 672 defining expected operating parameters associated with a particular geographic area at a particular travel time. The parameter data accessed by skylane route assessment system 624 can also include updated parameter data 674 defining current, real-time, or near real-time operating parameters associated with the particular geographic area at a particular travel time.

In some instances, the estimated parameter data 672 can serve as predicted parameter data used to evaluate skylanes in a first iteration as part of a first route assessment at a first time that is farther from a particular travel time for an aircraft and/or skylane. The updated parameter data 674 can be used to evaluate skylanes in at least a second iteration as part of a second route assessment at a second time that is closer to a particular travel time for an aircraft and/or skylane. In other words, estimated parameter data 672 can be used for a first route assessment at a first time, while updated parameter data 674 can be used for a second route assessment at a second time that is subsequent to the first time of the first route assessment. Additional iterations of route assessments at a third time, fourth time, etc. can also be employed. By conducting multiple route assessments across multiple different times, route assessments can be conducted as early as possible for planning purposes but refined for greater accuracy closer to an actual travel time.

Route assessments computed by skylane route assessment system 624 can be configured to evaluate an operating constraint associated with respective skylanes relative to the estimated parameter data. In some implementations, the route assessment determines that an operating constraint for a particular skylane can be met given the parameter data from parameter database 640. In some implementations, the route assessment determines that an operating constraint for a particular skylane cannot be met given the parameter data from parameter database 640. For example, consider an operating constraint for a particular skylane that includes a noise limit defining a threshold audible noise level established for the particular geographic area including the particular skylane. If current noise data 648 for the particular skylane indicates that the noise level remains below the noise limit established by the operating constraint, then the particular skylane can remain open. If current noise data 648 for the particular skylane indicates that the noise level exceeds the noise limit established by the operating constraint, then the particular skylane can be closed. Opening and closing of skylanes is further described herein with respect to skylane route activation system 626.

In the context of skylane route activation system 626, respective skylanes can be activated (or opened) and/or deactivated (or closed) based at least in part on the route assessments conducted by skylane route assessment system 624. For instance, a subset of skylanes less than or equal to all skylanes in a network of skylanes can be activated when parameter data associated with those skylanes indicates that those skylanes satisfy the various operating constraints relative to parameter data as evaluated by skylane route assessment system 624. For skylanes having parameter data that violate or otherwise fail to satisfy operating constraints, that subset of skylanes can be deactivated or closed within the network of skylanes. Activation of a subset of skylanes can define that subset as available skylanes for eVTOL travel, while deactivation of a subset of skylanes can define that subset as unavailable skylanes for eVTOL travel. It should be appreciated that the activation and/or deactivation implemented by skylane route activation system 626 can be computed on a periodic basis such that the activation/deactivation can change as parameters are updated over time.

Activation and/or deactivation of skylanes by skylane route activation system 626 can be implemented on entire skylanes or particular portions thereof. For instance, skylane route assessment system 624 can evaluate segments of a skylane. Segments can correspond to a portion of a skylane defined by a particular length or volume (e.g., every 100 yards, every cubic decimeter, etc.) Instead of evaluating an entire skylane at once, segments of skylanes are evaluated on an individual basis to determine if the segments respectively satisfy an operating constraint relative to current parameter data. If a segment is computed to satisfy the operating constraint, then the segment can be activated as available for eVTOL travel by skylane route activation system 626. If a segment is computed to violate the operating constraint, then the segment (and by default the entire skylane) can be deactivated as unavailable for eVTOL travel. Skylane route assessment system 624 can additionally or alternatively evaluate multiple altitude profiles for a particular skylane. When an altitude profile satisfies an operating constraint relative to parameter data, that altitude profile can be activated as available for eVTOL travel. When an altitude profile violates an operating constraint relative to parameter data, that altitude profile can be deactivated as unavailable for eVTOL travel.

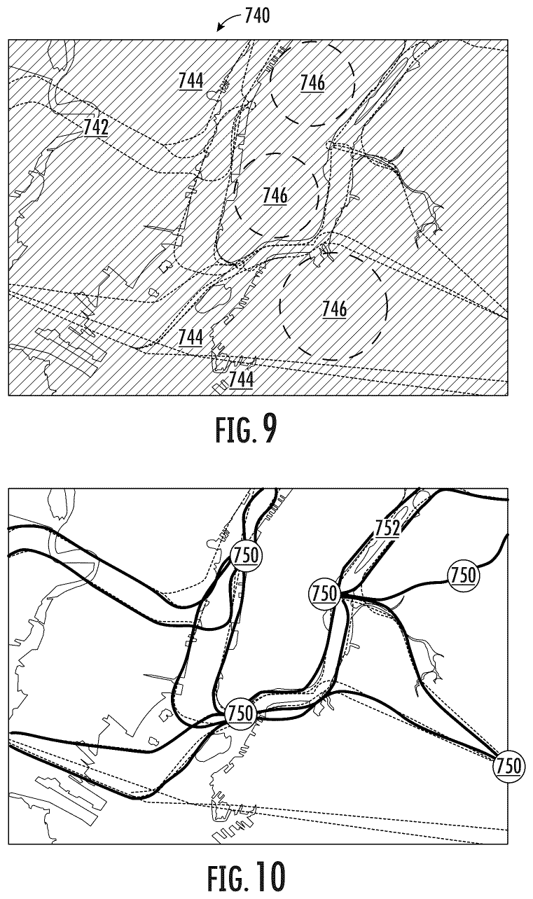

Activation and/or deactivation of skylanes by skylane route activation system 626 can be implemented on nodes and edges of a skylane network when the network is represented using a directed graph representation of nodes and edges. For example, if vertiports or other locations in a particular geographic area correspond to nodes in a directed graph representation and skylanes or segments of skylanes correspond to edges in the directed graph representation, activating a subset of skylanes in a network of skylanes can correspond to activating and/or deactivating a subset of the nodes and edges within the directed graph representation as available/unavailable for aircraft travel. Examples of node and edge activation such as implemented by skylane route activation system 626 are depicted in FIGS. 8A-8B and 9A-9B.

In the context of dynamic skylane updating system 628, skylane network data 670 or skylane route data for particular skylanes in the skylane network can be updated based on the route assessments computed by skylane route assessment system 624 and/or the activation/deactivation of skylanes or portions thereof computed by skylane route activation system 626. The instances of skylane network data 670 or portions thereof can be maintained in a skylane network database within skylane network generation system or can be relayed to a separate location, such as a trip assignment generation system 660 that uses skylane network data 670 to assign and deploy a particular eVTOL to travel on a particular skylane (e.g., a skylane in an activated subset of skylanes) in the skylane network. Dynamic skylane updating system 628 can additionally or alternatively be configured to generate visual content for presentation via a user interface (e.g., a map-based user interface) accessible by a computing system of an aircraft, an ATP platform, a passenger device, pilot device, or the like. For instance, the visual content can include the directed graph representation of the particular skylane, including nodes, edges, and waypoints associated with the particular skylane. The dynamic skylane updating system 628 can also be configured to initiate presentation of the visual content including the directed graph representation of the particular skylane on the map-based user interface. For example, the directed graph representation of the particular skylane can be overlayed on or integrated with (e.g., as a layer or feature of) map data for display on the map-based user interface.

Referring still to FIG. 6, trip assignment generation system 660 can be configured to access data within the dynamic aircraft routing system 600 to help generate a trip assignment that is used to assign and deploy a particular eVTOL to travel on a particular skylane in a skylane network. For example, trip assignment generation system 660 can be configured to access data from skylane network generation system 620 (e.g., including but not limited to skylane network data 670), parameter data from parameter database 640, and/or trip request data 684, such as obtained over network 680 from user device 682. In some examples, user device 682 can be operated by a user of an aviation transport application, ridesharing application, or the like. Trip request data 684 obtained from user device 682 can define a trip request for transport at a particular travel time from an origin location to a destination location within a particular geographic area. Trip request data 684 can more particularly include passenger data for a trip (e.g., a number of passengers, passenger identifiers), an amount of goods and/or luggage for a trip (e.g., payload weight), an origin location for a trip, a destination location for a trip, a particular travel date for a trip, a particular travel time for a trip, or other trip-related information.

Trip assignment generation system 660 can be configured to select one or more particular skylane(s) to service a trip request and to select particular aircraft for servicing the trip request. Trip assignment generation system 660 can also compute a departure time for deployment of the particular aircraft into the selected skylane(s). These skylane and aircraft determinations can be based on aircraft itinerary, types of aircraft and operators/owners (e.g., 1P vs. 3P aircraft), aircraft operating characteristics, etc. Additional details can be related to a timing sequence of deploying aircraft into skylanes and coordinating across multiple skylanes (e.g., adjacent skylanes).

Trip assignment generation system 660 of FIG. 6 can access trip request data 684 and skylane network data 670 in order to compute a subset of the plurality of skylanes as candidate skylanes for servicing a trip request. The candidate skylanes can be determined based on a route assessment configured to evaluate an operating constraint associated with respective skylanes relative to parameter data for the particular geographic area at the particular travel time. This function is similar to that computed by the skylane route assessment system 624, and indeed such function can be performed as part of skylane network generation system 620 as opposed to within the trip assignment generation system 660. The operating constraints that can be utilized to conduct a route assessment for determining candidate skylanes for serving a trip request can include, for example: (i) a type of eVTOL aircraft designated for travel on the respective skylanes of the plurality of skylanes; (ii) a speed for eVTOL aircraft designated for travel on the respective skylanes of the plurality of skylanes; (iii) a noise limit defining a threshold visual noise level or a threshold audible noise level established for the particular geographic area; and/or (iv) a weather condition limit defining an acceptable level of a temperature, a pressure, a wind condition, or a visibility condition established for the particular geographic area. The parameter data used relative to the operating constraint to assess skylanes can include: (i) location parameter data defining takeoff and landing paths for other aircraft operating in the particular geographic area, (ii) noise level data defining a visual noise level or an audible noise level determined for the particular geographic area, (iii) weather data defining at least one of a temperature, a pressure, a wind condition, or a visibility condition determined for the particular geographic area, and/or (iv) location data from an application associated with a pilot or a passenger currently traveling on a particular skylane of the plurality of skylanes. In some examples, candidate skylanes for servicing a trip request can be determined by implementing a first computing iteration based on predicted parameter data for the particular geographic area at the particular travel time and implementing a second skylane iteration based on updated or real-time parameter data (e.g., parameter data obtained at a time subsequent to the first iteration) for the particular geographic area at the particular travel time.

Trip assignment generation system 660 can also be configured to compute a selected skylane 662 from the candidate skylanes for servicing the trip request. When the plurality of skylanes are respectively depicted as a directed graph representation of nodes and edges, computing the selected skylane for serving at least a portion of a trip request can include determining a path along edges in the directed graph representation that minimize a cost function between a node corresponding to the origin location and a node corresponding to the destination location. In some examples, determining the selected skylane 662 can be based on historical trip data indicative of previous trips between the origin location and the destination location.

Trip assignment generation system 660 can also be configured to compute a selected aircraft 664 for servicing the trip request. In some instances, a plurality of candidate aircraft 632 are computed from among a fleet of aircraft for servicing the trip request at the particular travel time. For example, aircraft network database 630 can store aircraft data for an entire fleet of aircraft and/or for a subset of the fleet corresponding to candidate aircraft 632. Candidate aircraft can be determined based on an aircraft assessment configured to evaluate an operating constraint associated with respective aircraft of the fleet of aircraft relative to parameter data for the particular geographic area at the particular travel time. For instance, an aircraft operating constraint may require that aircraft have a current battery charge greater than a threshold level (e.g., a threshold voltage level, a threshold percentage level of total charge capacity, etc.) in order to be considered in the subset of candidate aircraft 632 for servicing a trip request. A selected aircraft 664 can then be determined from the plurality of candidate aircraft for servicing the trip request at the particular travel time. Methods for computing the selected aircraft 664 can be based on cost function analysis, machine-learned models, or other evaluation methods.

Trip assignment generation system 660 can also be configured to compute a departure time 666 for deployment of the selected aircraft 664 from the origin location into the selected skylane 662. The departure time 666 can be determined based on the particular travel time and updated parameter data associated with the plurality of skylanes at the particular travel time. Departure time 666 can be computed based on one or more adjustments to a particular travel time (e.g., a travel time defined by the trip request data 684). A first example adjustment to the particular travel time used to determine departure time 666 can be based on availability of an aircraft, pilot, and/or additional passengers. For instance, although a particular passenger may request a particular travel time, that time may need to be adjusted sooner or later based on an arrival time at a departure vertiport of an aircraft, pilot, and/or additional passengers assigned to the same aircraft. A second example adjustment to the particular travel time used to determine departure time 666 can be based on other aircraft assigned for deployment into the selected skylane before the particular travel time. For instance, if another aircraft is assigned for deployment into the same skylane thirty seconds before a particular travel time and one minute is required between aircraft deployments, then the departure time 666 for selected aircraft 664 can be adjusted later by thirty seconds or more to accommodate the required spacing. A third example adjustment to the particular travel time used to determine departure time 666 can be based on other aircraft assigned for deployment into the selected skylane after the particular travel time. For instance, if another aircraft is assigned for deployment into the same skylane thirty seconds after a particular travel time and one minute is required between aircraft deployments, then the departure time 666 for selected aircraft 664 can be adjusted earlier by thirty seconds or more to accommodate the required spacing between successive deployments. A fourth example adjustment to the particular travel time used to determine departure time 666 can be based on updated parameter data for a particular geographic area associated with the selected skylane. For instance, if updated parameter data indicates a weather condition associated with the selected at a particular travel time, then departure time 666 can be adjusted to a time when the parameter data is predicted to change and satisfy an operating constraint of the skylane.

FIGS. 7-10 depict respective map diagrams depicting aspects associated with the computation of skylanes relative to airspace data accessed by a computing system, such as but not limited to the dynamic aircraft routing system 600 of FIG. 6.

With more particular reference to FIG. 7, a graphical representation of map data 700 is depicted. Map data 700 can correspond, for example, to regional map data 612 for a particular geographic area obtained from airspace database 610. The map data 700 in FIG. 7 depicts a particular geographic area corresponding to a portion of New York City. Assuming that an initiating event is detected to add a new skylane into this particular geographic area, skylane route generation system 622 can request access to map data 700, corresponding to high-definition map data for the region corresponding to that illustrated in FIG. 7. Skylane route generation system 622 can also request access to aircraft track data 710. Aircraft track data 710 of FIG. 7. can correspond, for example, to aircraft track data 614 of FIG. 6. Aircraft track data 710 such as depicted in FIG. 7 can be in the form of geographic datapoints (e.g., three-dimensional tracks with points defined in a first dimension, second dimension, and third dimension—e.g., latitude, longitude, and altitude). The aircraft track data 710 of FIG. 7 can be from aircraft that have similar operational characteristics to the aircraft (e.g., eVTOL aircraft) associated with the skylane network generated by skylane route generation system 622. In some examples, skylane route generation system 622 can generate skylanes that generally track with the type of aircraft track data 710 depicted in FIG. 7.

Referring now to FIG. 8, graphical representation 720 includes the same map data 700 and aircraft track data 710 of FIG. 7, with the addition of restricted zone data. The restricted zone data depicted in FIG. 8 can correspond, for example, to restricted zone data 616 of FIG. 6, which can include geographic or map-based data indicative of portions of a particular geographic area that are unavailable for eVTOL travel. The restricted zone data of FIG. 8 includes location data associated with takeoff and landing paths 722 for other aircraft operating in the particular geographic area. The restricted zone data of FIG. 8 additionally includes location data associated with no-fly zones 724. In some examples, a skylane route generation system 622 can generate skylanes that generally avoid or exclude the restricted zones indicated as takeoff and landing paths 722 and no-fly zones 724.

Referring now to FIG. 9, a graphical representation 740 includes a depiction of airspace data including available portions of airspace and unavailable portions of airspace for eVTOL aircraft travel. Available portions of airspace correspond to those in which new skylanes can be generated, while unavailable portions of airspace correspond to those that should be avoided or excluded from skylane generation. More particularly, available portion 742 of the particular geographic area depicted in FIG. 9 indicates the available portion of airspace associated with the particular geographic area. Unavailable portions 744 are based on and generally encompass the takeoff and landing paths 722 for other aircraft operating in the particular geographic area as depicted in FIG. 8. Unavailable portions 746 are based on and generally encompass the no-fly zones 724 depicted in FIG. 8. In some examples, skylane route generation system 622 can generate skylanes within the available portions of airspace that avoid or exclude the unavailable portions of airspace.

Referring now to FIG. 10, a graphical depiction of new skylanes generated within the particular geographic area are superimposed on top of the map data and aircraft track data of FIG. 7. The skylane route data depicted in FIG. 10 is in the form of a graph representation of nodes and edges, although it should be appreciated that any of the various types of skylane route data described herein or otherwise deemed to be suitable can be utilized. Nodes 750 in FIG. 10 correspond to various vertiports within the particular geographic area and/or waypoints within the particular geographic area. Edges 752 correspond to paths between the nodes 750.

FIGS. 11-14 depict respective diagrams depicting aspects associated with route assessments within a skylane network and activation of various skylanes therein. With more particular reference to FIG. 11, example skylane route data 800 can be in the form of a graph representation of nodes and edges. Nodes 802 of skylane route data 800 correspond to various vertiport locations and/or intermediate waypoints between vertiport locations. Edges 804 of skylane route data 800 correspond to generated skylane paths between the locations associated with nodes 802. In one example, FIG. 11 can correspond to all skylanes available between node locations in a particular geographic area.

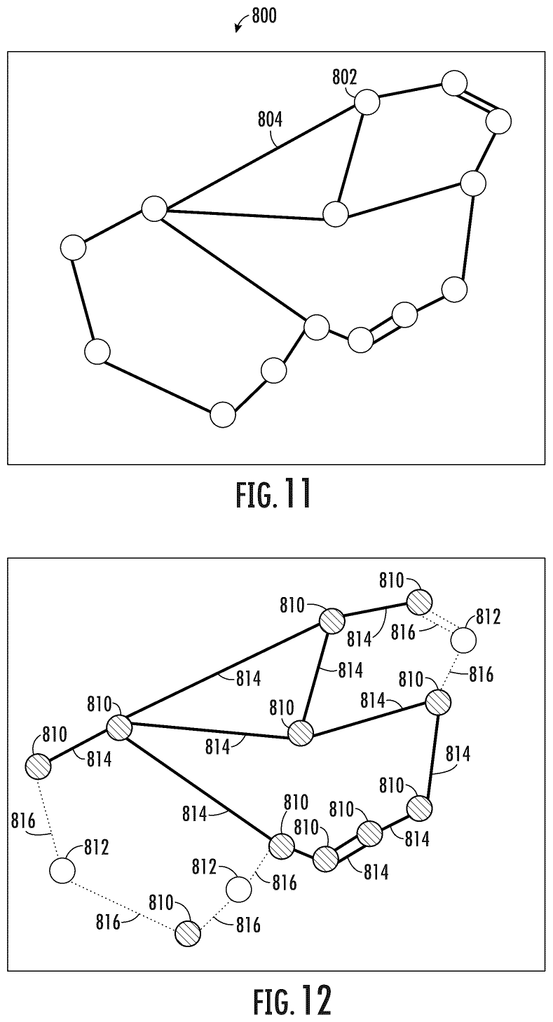

Turning now to FIG. 12, consider that signal processing implemented by dynamic aircraft routing system 600 results in an indication that a first set of nodes 810 are available at a particular travel time and a second set of nodes 812 are not available. The determination of available nodes and/or unavailable nodes can be based on a variety of computations. For instance, available nodes 810 may correspond to vertiports that have come online from an operational perspective and have sent a registration signal to a fleet operator or other computing system within an aviation transport network. In another example, available nodes 810 can correspond to vertiports/waypoints having operational constraints that are satisfied based on predicted or actual parameter data. Unavailable nodes 812 can correspond to vertiports/waypoints having operational parameters that are violated based on predicted or actual parameter data. Based on the indication of FIG. 8, nodes 810 can be considered as activated nodes while nodes 812 can be considered deactivated nodes. Activation of corresponding edges representative of skylane paths can be based on the activation of available nodes 810. For instance, edges 814 correspond to available skylanes, while edges 816 correspond to unavailable skylanes. An edge 814 can be activated as an available skylane when both a first node at one end of the edge 814 and a second node at an opposite end of the edge 814 are activated. If one or both of the two nodes on either end of an edge is deactivated, than that edge 816 can be deactivated. Available skylanes as represented by the activated edges 814 of FIG. 12 can be used for subsequent analysis, including trip analysis and assigning and deploying aircraft into only activated skylanes.

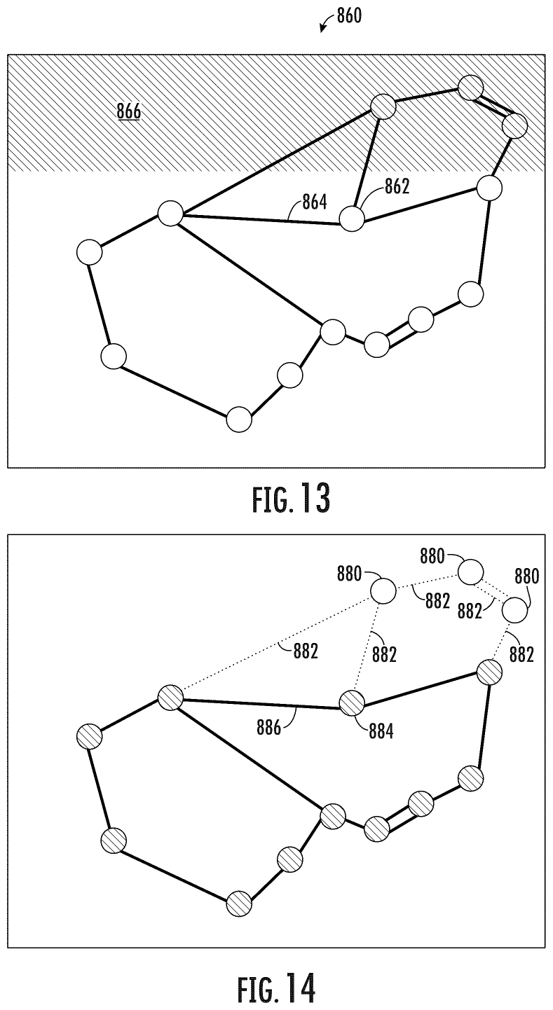

Turning now to FIG. 13, example skylane route data 860 can be in the form of a graph representation of nodes and edges. Nodes 862 of skylane route data 860 can correspond to various vertiport locations and/or intermediate waypoints between vertiport locations. Edges 864 of skylane route data 860 correspond to generated skylane paths between the locations associated with nodes 862. Area 866 in FIG. 13 is intended to depict a portion of parameter data measured for the particular geographic area represented in FIG. 13. For instance, area 866 can correspond to a visibility condition detected within a portion of the particular geographic area represented in FIG. 13. The visibility condition associated with area 866 can correspond to a visibility ceiling that is lower than an operating constraint. In response to a route assessment that evaluates operating constraints associated with skylanes corresponding to edges 864 relative to the parameter data represented by area 866, a determination can be made (e.g., by skylane route assessment system 624) that the parameter data of area 866 violates operating constraints associated with nodes 880 and edges 882. As such nodes 880 and edges 882 are deactivated, while nodes 884 and edges 886 are activated. In the example of area 866 corresponding to a visibility condition, the parameter data defining the visibility condition may indicate a ceiling of 400 feet, while an operating constraint for skylanes corresponding to edges 882 requires a ceiling of greater than 500 feet. Because nodes 880 have only a 400 ft ceiling, the skylane route assessment system 624 can activate nodes 884 and edges 886 while deactivating nodes 880 and edges 882.

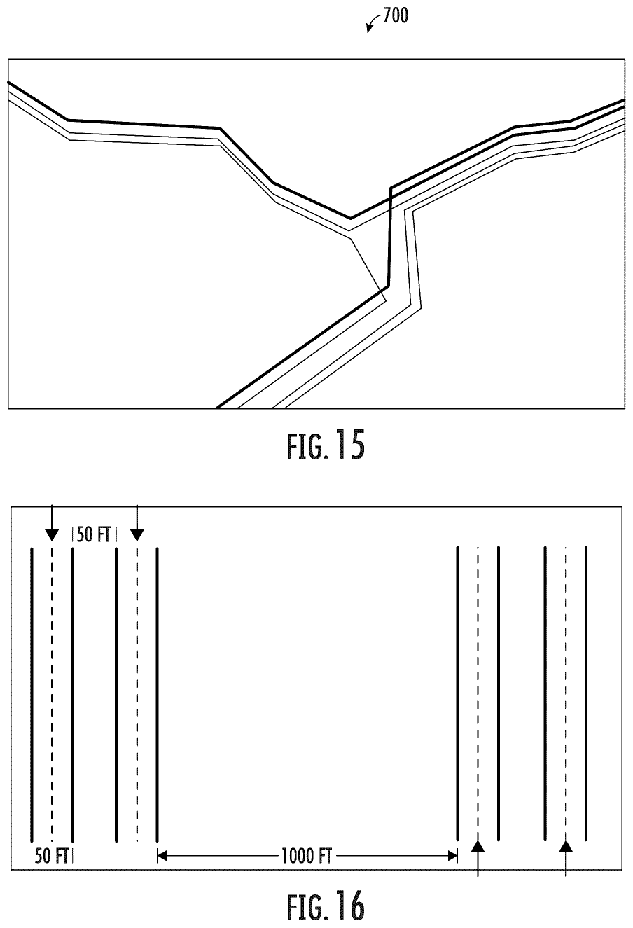

An example of a network of flight paths or skylanes is shown in FIG. 15 and an example skylane layout is shown in FIG. 16. Because skylanes (shown as lines in FIG. 15) can be designated at different altitude profiles, the skylanes can cross over each other as shown in FIG. 15. Additionally, aircraft can transition from one skylane to another skylane. Skylanes can be generated to accommodate one or more aircraft in one or more directions. In one embodiment, skylanes going in the same direction at a same altitude are positioned a minimum distance (e.g., 50 feet) apart from each other. Additionally, skylanes traveling in opposite directions at the same altitude are positioned a minimum distance (e.g., 1000 feet) apart from as shown in FIG. 16. In one embodiment, more skylanes can be added in one direction during higher demand times (e.g., by reducing skylanes in the opposite direction).

Example embodiments are directed to generating an optimized network of skylanes and an operations volume around each of these skylanes in which an aircraft should operate. A network system (e.g., a transport network coordination system) creates a source network of paths, whereby the source network comprises a set of possible paths between two locations. The network system assigns a cost for traversing each edge of each path of the source network and aggregates the cost for traversing each edge of each path to obtain a cost for each path of the source network. Based on the cost for each path, the network system identifies a path having the lowest cost, whereby the path having the lowest cost is the computed route between the two locations. The network system then generates an operations volume or other skylane route data for the particular skylane. The skylane route data can be transmitted to a further system for use. As such, example embodiments provide the technical effect of enhancing flight planning and improving flight paths.

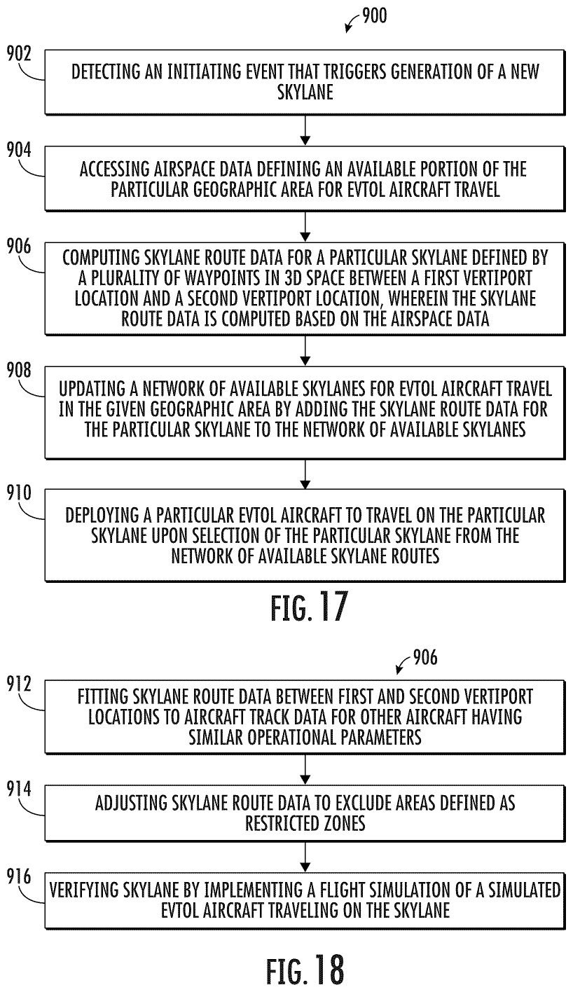

FIGS. 17-27 are flowchart diagrams of example methods according to example embodiments of the present disclosure. The methods can be performed by a computing system that includes one or more computing devices such as, for example, the computing systems described with reference to the other figures herein. Each respective portion of the methods can be performed by any (or any combination) of one or more computing devices. Moreover, one or more portions of these methods can be implemented as one or more algorithms on the hardware components of the devices described herein (e.g., as in FIGS. 4-6, 28, etc.), for example, to generate and dynamically update a network of skylanes for aircraft travel in a particular geographic area and to assign and deploy selected aircraft into particular skylanes.

FIGS. 17-27 depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

FIGS. 17-27 are described with reference to elements/terms described with respect to other systems and figures for exemplary illustrated purposes and is not meant to be limiting. One or more portions of the methods can be performed additionally, or alternatively, by other systems.

FIG. 17 depicts a flowchart diagram of an example method 900 for generating a network of skylanes for aircraft travel in a particular geographic area according to example implementations of the present disclosure.

At step 902, a computing system can detect an initiating event that triggers generation of a new skylane. For example, detecting an initiating event at step 902 can correspond to the designation of a new vertiport for eVTOL aircraft operation. New vertiports can correspond, for example, to one of the aerial facilities 205A-E depicted in FIG. 2. Additionally, or alternatively, detecting an initiating event at step 902 can correspond to a request for a new skylane relative to an existing vertiport within the eVTOL transport network. A new skylane may be needed to address changing operation of the eVTOL transport network. For instance, a new skylane may be needed to accommodate an increased volume of trip requests relative to the existing vertiport, a decommissioning of an existing skylane (e.g., for failure to satisfy operating constraints associated with the existing skylane), etc. The request for a new skylane relative to an existing vertiport can be initiated automatically based on route assessments, or can be initiated based on a manual request for new skylanes from an entity, such as but not limited to an aircraft provider or aerial facility operator. Still further, skylane route generation system 622 can detect an initiating event corresponding to a trip request for transport of passengers and/or goods within a particular geographic area. For example, trip request data 684 from a user device 682 (or from another entity such as a service provider of ground and/or aerial vehicles) can include a first vertiport location and a second vertiport location between which aerial transport is requested. In response to receipt of the trip request data 684, skylane route generation system 622 can be triggered to generate skylane route data for a new skylane between the first vertiport location and the second vertiport location.

At step 904, a computing system can access airspace data defining an available portion of the particular geographic area for eVTOL aircraft travel. In some examples, the airspace data accessed at step 904 can include aircraft track data indicative of locations traveled by an aircraft in the particular geographic area. An example of aircraft track data obtained at step 904 can include aircraft track data 614 described with reference to FIG. 6 and/or the aircraft track data 710 depicted in FIGS. 7 and 8. In some examples, the airspace data accessed at step 904 can include restricted zone data defining portions of the particular geographic area that are unavailable for the eVTOL travel. An example of restricted zone data obtained at step 904 can include restricted zone data 616 described with reference to FIG. 6 and/or the restricted zone data depicted in FIG. 8. More particularly, restricted zone data accessed at step 904 can include location data associated with takeoff and landing paths for other aircraft operating in the particular geographic area (e.g., takeoff and landing paths 722 depicted in FIG. 8). Restricted zone data accessed at 702 can additionally or alternatively include no-fly zones designated by a regulating body of the airspace (e.g., no-fly zones 724 depicted in FIG. 8).

At step 906, a computing system can compute skylane route data for a particular skylane. The skylane route data computed at 906 can include a plurality of waypoints in three-dimensional (3D) space between a first vertiport location and a second vertiport location, wherein the skylane route data is based on the airspace data accessed at step 904. The skylane route data computed at 906 for a particular skylane can be based on aircraft track data. More particularly, determining a plurality of waypoints in three-dimensional space relative to the aircraft track data can include determining a plurality of waypoints that are within a threshold distance of at least one of a plurality of previously flown aircraft tracks between a first vertiport location (or location near a first vertiport location) and a second vertiport location (or location near a second vertiport location). Tracking with previously flown aircraft tracks for aircraft having similar operating parameters can help generate new skylanes for eVTOL aircraft based on previously tested aircraft tracks that have been proven as safe and effective for aircraft operation. The skylane route data computed at 906 for a particular skylane can also be based on restricted zone data. More particularly, determining a plurality of waypoints in three-dimensional space relative to the restricted zone data can include determining a plurality of waypoints that exclude or avoid the restricted zones. In some examples, the plurality of waypoints determined at step 906 are greater than a threshold distance away from the restricted zones. For example, unavailable airspace volumes may be determined around restricted zones, such as represented by unavailable portions 744 and 746 of FIG. 9.

In some implementations, computing skylane route data for a particular skylane at step 906 can include computing first skylane route data and second skylane route data. The first skylane route data can define a first plurality of waypoints for travel in a first direction from the first vertiport location to the second vertiport location. The second skylane route data can define a second plurality of waypoints for travel in a second direction from the second vertiport location to the first vertiport location.

In some implementations, computing skylane route data for a particular skylane at step 906 can include computing a plurality of altitude profiles associated with the plurality of waypoints in three-dimensional space. For example, skylane route data can include fixed waypoints in latitudinal and longitudinal dimensions and a plurality of altitude profiles from which to select among. The plurality of altitude profiles can include, for example, a first altitude profile at a first altitude, a second altitude profile at a second altitude that is different than the second altitude, a third altitude that is different than the first altitude and the second altitude, etc.

In some implementations, computing skylane route data for a particular skylane at step 906 can include computing an operational volume defining a three-dimensional corridor of airspace around a route associated with the particular skylane between the first vertiport location and the second vertiport location. The operational volume represents a piece (or segment) of airspace that surrounds a flight path, route, or trajectory. In one example, an operational volume is a three-dimensional representation of the skylane between two locations (e.g., first vertiport location and second vertiport location). In other examples, the operational volume is defined by the four-dimensional coordinates of its sectional geometry. The types of geometry include, for example, a polygon with a rectangular section having eight vertices (e.g., four on a bottom section and four on a top section) and a tube with a circular section defined by a radius and a length of the tube. Different types of geometry can be used for different types of aircraft and/or based on the preference of an entity associated with the aircraft (e.g., vendor, manager, manufacturer, third-party operator). In some examples, a vehicle (e.g., aircraft) configuration performance can be taken into consideration to define an operational volume. For example, if the aircraft flies vertically (e.g., a VTOL), it may not need as large of volume to fly in as other types of aircraft. As such, the volume can be reduced around the configuration performance since the aircraft is good at climbing vertically. As such, the operational volume generation process can build static volume around routes but can also create volumes that are appropriate around aircraft type to match its profile instead of being bigger to encompass more possibilities.

In some implementations, computing skylane route data for a particular skylane at step 906 can include computing a directed graph representation of nodes and edges, the first vertiport location and the second vertiport location corresponding to nodes within the directed graph representation. In some implementations, the waypoints between the first vertiport location and the second vertiport location also correspond to nodes within the directed graph representation. In this way, segments of skylanes defined between waypoints can be generated and/or subsequently evaluated and/or updated such that portions of skylanes can be advantageously analyzed on a more granular level. The directed edges between nodes in the directed graph representation (e.g., nodes corresponding to first and second respective vertiport locations) can include, for example, a first directed edge corresponding to a first direction of travel from the first vertiport location to the second vertiport location and a second directed edge corresponding to a second direction of travel from the second vertiport location to the first vertiport location.

In some implementations, computing skylane route data for a particular skylane at step 906 can include computing one or more operating constraints associated with the particular skylane. For instance, an operating constraint associated with respective skylanes of a skylane network can include a type of eVTOL aircraft designated for travel on the respective skylanes. In another example, an operating constraint associated with respective skylanes can include a speed for eVTOL aircraft designated for travel on the respective skylanes. In yet another example, an operating constraint associated with respective skylanes can include a noise limit defining a threshold visual noise level or a threshold audible noise level established for the particular geographic area. Still further, an operating constraint associated with respective skylanes can include a weather condition limit defining an acceptable level of a temperature, a pressure, a wind condition, or a visibility condition established for the particular geographic area. Operating constraints associated with particular skylanes can be defined in terms of one or more ranges of acceptable values or one or more threshold values (e.g., a minimum threshold value a parameter must exceed or a maximum threshold value a parameter must subceed). Operating constraints associated with particular skylanes can be stored in the form of metadata defining the operating constraint along saved in conjunction with skylane route data for the particular skylanes in the skylane network. Still further aspects of computing skylane route data for a particular skylane at step 906 are described with reference to FIG. 18.

At step 908, a computing system can update a network of available skylanes for eVTOL aircraft travel in the particular geographic area by adding the skylane route data for the particular skylane to the network of available skylanes. Instances of a skylane network and skylane route data for particular skylanes in the skylane network can be stored, updated, and maintained in a skylane network database within skylane network generation system or can be relayed to a separate location, such as a trip assignment generation system or the like. Adding skylane route data for a particular skylane to a network of available skylanes can include storing additional information associated with a skylane, including but not limited to additional details for the plurality of waypoints as well as metadata indicative of one or more operating constraints defined for the particular skylane (e.g., type of aircraft, speed limit of aircraft, noise limit for skylane, weather limits for skylane, volume of air traffic on skylane, etc.)

At step 910, a computing system can deploy a particular e VTOL aircraft to travel on the particular skylane upon selection of the particular skylane from the network of available skylanes. In some examples, deploying a particular eVTOL aircraft at step 910 can include providing deployment instructions to initiate takeoff of the eVTOL aircraft into the particular skylane (e.g., to fulfill a trip assignment). Deploying a particular aircraft at step 910 to travel on the particular skylane upon selection of the particular skylane does not necessarily limit step 910 to occurring immediately upon selection of the particular skylane. Instead, deploying a particular aircraft at step 910 may occur after implementing additional intervening operations or determining additional conditions being met in between selection of a particular skylane and deploying an aircraft into the particular skylane. In other words, additional or alternative conditions may be needed beyond selection of a particular skylane to trigger aircraft deployment. Further aspects of deploying a particular eVTOL aircraft to travel on a particular skylane are described with reference to FIG. 22.

FIG. 18 depicts a flowchart diagram of an example method for computing skylane route data for a particular skylane according to example implementations of the present disclosure. The method of FIG. 18 provides an example of additional operations associated with step 906 of FIG. 17.

At step 912, a computing system can fit skylane route data between first and second vertiport locations to aircraft data for other aircraft having similar operational parameters. Fitting skylane route data at step 912 can include determining a plurality of waypoints in three-dimensional space that are within a threshold distance of at least one of a plurality of previously flown aircraft tracks between a first vertiport location (or location near a first vertiport location) and a second vertiport location (or location near a second vertiport location). Tracking with previously flown aircraft tracks for aircraft having similar operating parameters can help generate new skylanes for eVTOL aircraft based on previously tested aircraft tracks that have been proven as safe and effective for aircraft operation.

At step 914, a computing system can adjust skylane route data to exclude areas defined as restricted zones. Adjusting skylane route data at step 914 can include adjusting the plurality of waypoints determined at step 912 to exclude or avoid the restricted zones. In some examples, the plurality of waypoints determined at step 912 can be adjusted at step 914 to be greater than a threshold distance away from the restricted zones.

At step 916, a computing system can verify a skylane by implementing a flight simulation of a simulated eVTOL aircraft traveling on the skylane. If the automated flight simulation implemented at step 916 is successful, then a newly generated skylane can be added to a skylane network. In some instances, the automated flight simulation may identify one or more updates to the newly generated skylane that must be made before being retested and potentially later added to the skylane network.

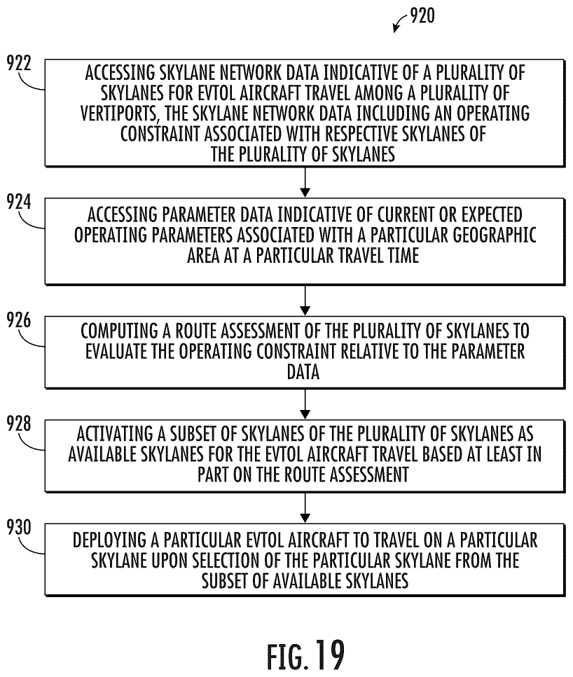

FIG. 19 depicts a flowchart diagram of an example method 920 for dynamically updating a network of skylanes for aircraft travel in a particular geographic area according to example embodiments of the present disclosure.

At step 922, a computing system can access skylane network data indicative of a plurality of skylanes for eVTOL aircraft travel among a plurality of vertiports. For example, the skylane network data accessed at step 922 can include accessing the skylane network data generated by skylane route generation system 622 of FIG. 6 and discussed with more particular reference to the method steps of FIGS. 17-18. In some examples, the skylane network data accessed at step 922 can include a directed graph representation of nodes and edges, wherein vertiports correspond to nodes of the directed graph representation, and skylanes correspond to edges of the directed graph representation.

The skylane network data accessed at step 922 can include an operating constraint associated with respective skylanes of the plurality of skylanes. For instance, an operating constraint associated with respective skylanes of a skylane network can include a type of eVTOL aircraft designated for travel on the respective skylanes. In another example, an operating constraint associated with respective skylanes can include a speed for eVTOL aircraft designated for travel on the respective skylanes. In yet another example, an operating constraint associated with respective skylanes can include a noise limit defining a threshold visual noise level or a threshold audible noise level established for the particular geographic area. Still further, an operating constraint associated with respective skylanes can include a weather condition limit defining an acceptable level of a temperature, a pressure, a wind condition, or a visibility condition established for the particular geographic area. Operating constraints associated with particular skylanes can be defined in terms of one or more ranges of acceptable values or one or more threshold values (e.g., a minimum threshold value a parameter must exceed or a maximum threshold value a parameter must subceed).

At step 924, a computing system can access parameter data indicative of current or expected operating parameters associated with the particular geographic area at a particular travel time. Parameter data accessed at step 924 can be accessed from a parameter database, such as parameter database 640 depicted in FIG. 6. Parameter data accessed at step 924 can include one or more portions of data associated with the operating environment of a particular geographic area in which eVTOL aircraft can be configured to travel. Parameter data accessed at step 924 can include, for example, aircraft data 642, weather data 644, wildlife data 646, noise data 648, payload data 650, and pilot/passenger application data 652, as depicted in FIG. 6. For example, parameter data accessed at step 924 can include location parameter data defining takeoff and landing paths for other aircraft operating in the particular geographic area. Parameter data accessed at step 924 can additionally or alternatively include noise level data defining a visual noise level or an audible noise level determined for a particular geographic area. Parameter data accessed at step 924 can additionally or alternatively include weather data defining at least one of a temperature, a pressure, a wind condition, or a visibility condition determined for the particular geographic area. Parameter data accessed at step 924 can additionally or alternatively include location data from an application associated with a pilot or passenger currently traveling on a particular skylane of a skylane network. Parameter data accessed at step 924 can additionally or alternatively include runway use data indicative of current runways in use at an aircraft facility within the particular geographic area.

In some implementations, the parameter data accessed at step 924 can include estimated parameter data and updated parameter data. Estimated parameter data (e.g., estimated parameter data 672 of FIG. 6) can define expected operating parameters associated with a particular geographic area at a particular travel time. Updated parameter data (e.g., updated parameter data 674 of FIG. 6) can define current, real-time, or near real-time operating parameters associated with the particular geographic area at a particular travel time.

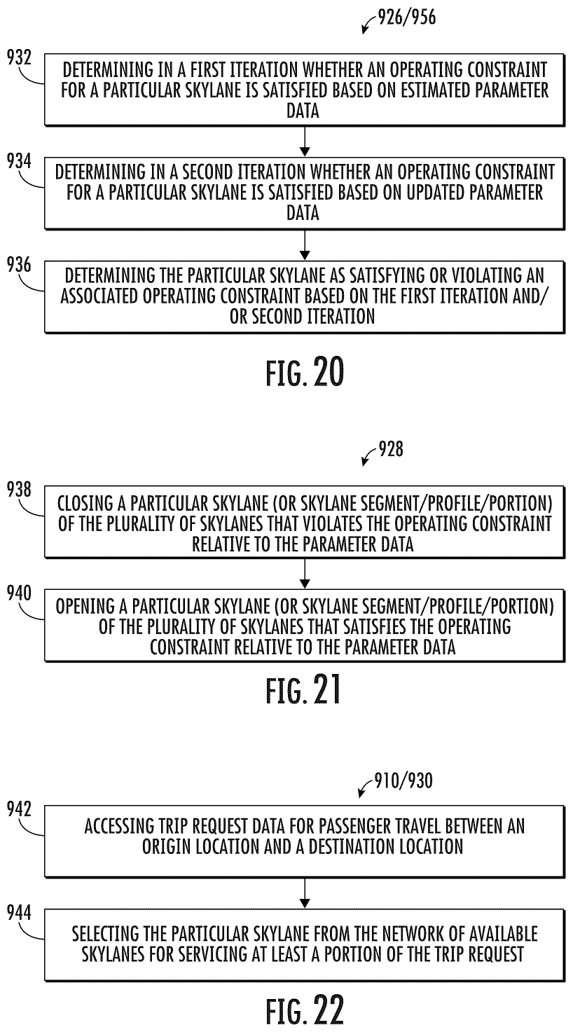

At step 926, a computing system can compute a route assessment of the plurality of skylanes to evaluate the operating constraint relative to the parameter data. Further aspects of computing a route assessment of a plurality of skylanes at step 926 are described with reference to FIG. 20. Computing a route assessment at step 926 can be implemented, for example, by a skylane route assessment system, such as skylane route assessment system 624 of FIG. 6.

Route assessments computed at step 926 can be configured to evaluate an operating constraint associated with respective skylanes relative to the estimated parameter data. In some implementations, the route assessment computed at step 926 determines that an operating constraint for a particular skylane can be met given the parameter data accessed at step 924. In some implementations, the route assessment computed at step 926 determines that an operating constraint for a particular skylane cannot be met given the parameter data accessed at step 924. For example, consider an operating constraint for a particular skylane that includes a noise limit defining a threshold audible noise level established for the particular geographic area including the particular skylane. If current noise data accessed at step 924 indicates that the noise level for a particular skylane remains below the noise limit established by the operating constraint, then the particular skylane can remain open. If current noise data accessed at 924 indicates that the noise level exceeds the noise limit established by the operating constraint, then the particular skylane can be closed. Opening and closing of skylanes is further described herein with respect to step 928 of method 920.

At step 928, a computing system can activate a subset of skylanes of the plurality of skylanes as available skylanes for the eVTOL aircraft travel based at least in part on the route assessment at step 926. Further aspects of activating a subset of skylanes at step 928 are described with reference to FIG. 21. Activating a subset of skylanes at step 928 can include opening particular skylanes that satisfy an operating constraint relative to parameter data. Deactivating a subset of skylanes at step 928 can include closing particular skylanes that violate an operating constraint relative parameter data. In some examples, activating a subset of skylanes as available skylanes for eVTOL aircraft travel includes activating a subset of nodes and edges within the directed graph representation, such as depicted in the examples of FIGS. 11-14. Activating a subset of skylanes at step 928 can be implemented for more granular portions of a skylane. For example, activating a subset of skylanes at step 928 can include activating one or more segments of a skylane based on computation in step 926 that evaluates whether operating constraints associated with particular segments of skylanes are satisfied relative to parameter data. Activating a subset of skylanes at step 928 can additionally or alternatively include activating one or more altitude profiles for a particular skylane based on computation in step 926 that evaluates whether operating constraints associated with particular profiles of skylanes are satisfied relative to parameter data.

At step 930, a computing system can deploy a particular eVTOL aircraft to travel on a particular skylane upon selection of the particular skylane from the subset of available skylanes. Further aspects of deploying a particular eVTOL aircraft to travel on a particular skylane at step 930 are described with reference to FIG. 22 and can be appreciated from the trip assignment generation system 660 of FIG. 6.

FIG. 20 depicts a flowchart diagram of an example method for computing a route assessment according to example embodiments of the present disclosure. The method of FIG. 20 provides an example of additional operations associated with step 910 of FIG. 12 and/or step 930 of FIG. 19.

At step 932, a computing system can determine in a first iteration whether an operating constraint for a particular skylane is satisfied based on estimated parameter data. The estimated parameter data utilized in the computation of step 932 can serve as predicted parameter data used to evaluate skylanes in a first iteration as part of a first route assessment at a first time that is farther from a particular travel time for an aircraft and/or skylane. In other words, a first computation iteration based on estimated parameter data at step 932 can be used for a first route assessment at a first time.

At step 934, a computing system can determine in a second iteration whether an operating constraint for a particular skylane is satisfied based on updated parameter data. The updated parameter data utilized in the computation of step 934 can be used to evaluate skylanes in at least a second iteration as part of a second route assessment at a second time that is closer to a particular travel time for an aircraft and/or skylane. In other words, a second computation iteration based on updated parameter data at step 934 can be used for a second route assessment at a second time at is subsequent to the first time of the first route assessment. Additional iterations of route assessments at a third time, fourth time, etc. can also be employed.

At step 936, a computing system can determine a particular skylane as satisfying or violating an associated operating constraint based on the first iteration determined at step 932 and/or the second iteration determined at step 934. By conducting multiple route assessments across multiple different times to implement the computation at step 936, route assessments can be conducted as early as possible for planning purposes but refined for greater accuracy closer to an actual travel time.

FIG. 21 depicts a flowchart diagram of an example method for activating a subset of skylanes as available skylanes according to example embodiments of the present disclosure. The method of FIG. 21 provides an example of additional operations associated with step 928 of FIG. 19.

At step 938, a computing system can close a particular skylane of a plurality of skylanes that violates the operating constraint relative to the parameter data. In some examples, the computing system can close one or more segments, altitude profiles, and/or other portions of a skylane. Referring to the example depicted in FIG. 12, skylanes associated with nodes 812 and/or edges 816 can be closed based on route assessments or other computations conducted on the network of skylanes. Referring to the example depicted in FIG. 14, skylanes associated with nodes 880 and/or edges 882 can be closed based on route assessments or other computations conducted on the network of skylanes.

At step 940, a computing system can open a particular skylane of a plurality of skylanes that satisfies the operating constraint relative to the parameter data. In some examples, the computing system can open one or more segments, altitude profiles, or other portions of a skylane. Referring to the example depicted in FIG. 12, skylanes associated with nodes 810 and/or edges 814 can be open based on route assessments or other computations conducted on the network of skylanes. Referring to the example depicted in FIG. 14, skylanes associated with nodes 884 and/or edges 886 can be open based on route assessments or other computations conducted on the network of skylanes.

FIG. 22 depicts a flowchart diagram of an example method for deploying a particular eVTOL aircraft to travel on a particular skylane according to example embodiments of the present disclosure. The method of FIG. 22 provides an example of additional operations associated with step 906 of FIG. 17.

At step 942, a computing system can access trip request data for passenger travel between an origin location and a destination location. Trip request data accessed at step 942 can correspond, for example, to trip request data 684 depicted in FIG. 6. Trip request data accessed at step 942 can be obtained from a user device and can define a trip request for transport at a particular travel time from an origin location to a destination location within a particular geographic area. Trip request data accessed at step 942 can more particularly include passenger data for a trip (e.g., a number of passengers, passenger identifiers), an amount of goods and/or luggage for a trip (e.g., payload weight), an origin location for a trip, a destination location for a trip, a date/time for a trip, or other trip-related information.

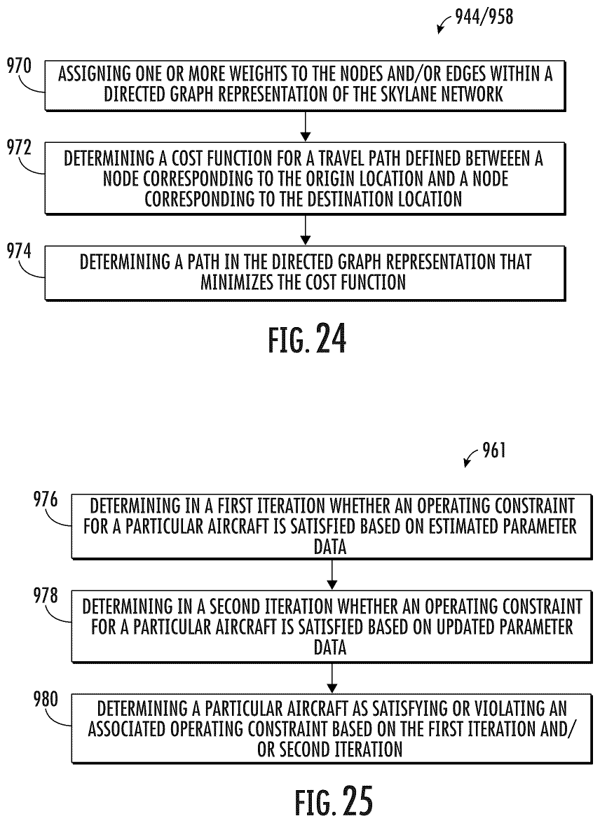

At step 944, a computing system can select the particular skylane from the network of available skylanes for servicing at least a portion of the trip request. Further aspects of computing a selected skylane at step 944 are described with reference to FIG. 24.

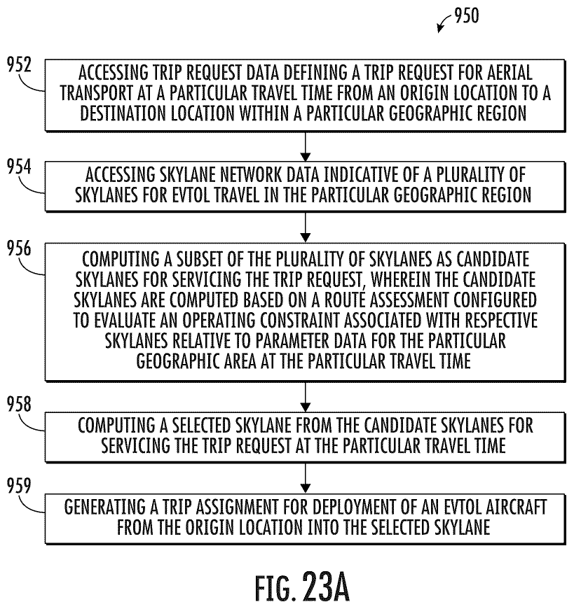

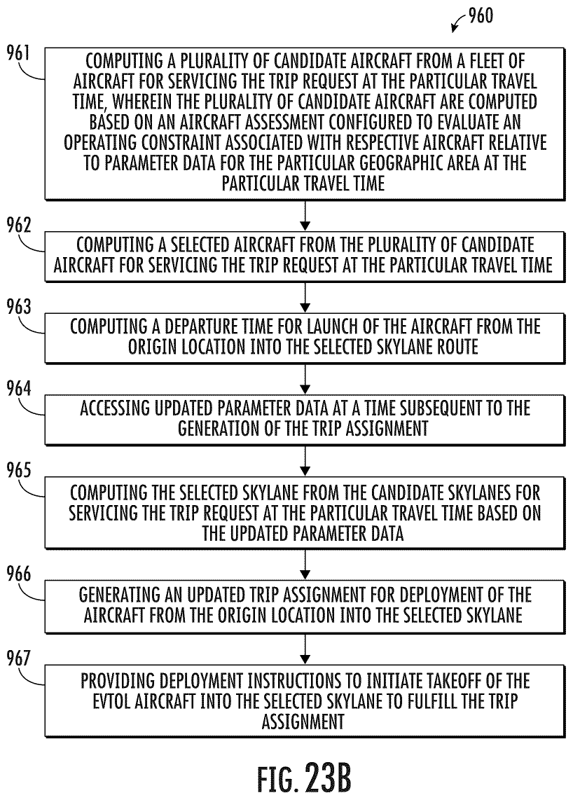

FIG. 23A depicts a flowchart diagram of an example method 950 of assigning an eVTOL aircraft to a skylane according to example embodiments of the present disclosure. FIG. 23B depicts a flowchart diagram of additional operations in a method 960, some or all of which may be selectively incorporated into the method 950 of FIG. 23A.

At step 952, a computing system can access trip request data defining a trip request for aerial transport at a particular travel time from an origin location to a destination location within a particular geographic area. For example, the trip request accessed at step 952 can include trip request data 684, such as that depicted in FIG. 6, having been obtained from user device 682. Trip request data accessed at step 952 can define a trip request for transport at a particular travel time from an origin location to a destination location within a particular geographic area. Trip request data 684 can more particularly include passenger data for a trip (e.g., a number of passengers, passenger identifiers), an amount of goods and/or luggage for a trip (e.g., payload weight), an origin location for a trip, a destination location for a trip, a particular travel date for a trip, a particular travel time for a trip, or other trip-related information.

At step 954, a computing system can access skylane network data indicative of a plurality of skylanes for eVTOL travel in the particular geographic area. For example, the skylane network data accessed at step 954 can include the skylane network data generated by skylane route generation system 622 of FIG. 6 and discussed with more particular reference to the method steps of FIGS. 17-18. In some examples, the skylane network data accessed at step 954 can include a directed graph representation of nodes and edges, wherein vertiports correspond to nodes of the directed graph representation, and skylanes correspond to edges of the directed graph representation.

The skylane network data accessed at step 954 can include an operating constraint associated with respective skylanes of the plurality of skylanes. For instance, an operating constraint associated with respective skylanes of a skylane network can include a type of eVTOL aircraft designated for travel on the respective skylanes. In another example, an operating constraint associated with respective skylanes can include a speed for eVTOL aircraft designated for travel on the respective skylanes. In yet another example, an operating constraint associated with respective skylanes can include a noise limit defining a threshold visual noise level or a threshold audible noise level established for the particular geographic area. Still further, an operating constraint associated with respective skylanes can include a weather condition limit defining an acceptable level of a temperature, a pressure, a wind condition, or a visibility condition established for the particular geographic area. Operating constraints associated with particular skylanes can be defined in terms of one or more ranges of acceptable values or one or more threshold values (e.g., a minimum threshold value a parameter must exceed or a maximum threshold value a parameter must subceed).

At step 956, a computing system can compute a subset of the plurality of skylanes as candidate skylanes for serving a trip request. The candidate skylanes computed at step 956 can be determined based on a route assessment configured to evaluate an operating constraint associated with respective skylanes relative to parameter data for the particular geographic area at the particular travel time. Aspects of computing a subset of the plurality of skylanes as candidate skylanes for servicing the trip request can include some of the features and techniques described with reference to steps 924-928 of FIG. 19.

At step 958, a computing system can compute a selected skylane from the candidate skylanes for servicing the trip request at the particular travel time. Further aspects of computing a selected skylane at step 958 are described with reference to FIG. 24.

At step 959, a computing system can generate a trip assignment for deployment of an eVTOL aircraft from the origin location into the selected skylane. A trip assignment generated at step 959 can include data and/or instructions for facilitating the fulfilment of the request for aerial transport set forth in the trip request accessed at step 952. For example, the trip assignment can include trip assignment data including the selected skylane, a selected e VTOL aircraft, the origin location, the destination location, time of aircraft deployment, passenger/payload details for the particular trip, and other related information as determined, for example, by the trip assignment generation system 660 of FIG. 6. In some instances, the trip assignment generated at step 959 can be transmitted to the scheduler 402 of FIGS. 4-5 so that the trip assignment can be included as part of the itinerary data structure 508. As such, the trip assignment generated at step 959 can include features of a user itinerary and/or multi-modal itinerary as described herein.

Referring now to FIG. 23B, at step 961, a computing system can compute a plurality of candidate aircraft from a fleet of aircraft for servicing the trip request at the particular travel time. The plurality of candidate aircraft computing at step 962 can be determined based on an aircraft assessment configured to evaluate an operating constraint associated with respective aircraft relative to parameter data for the particular geographic area at the particular travel time. Further aspects of computing a selected aircraft at step 962 are described with reference to FIG. 25.

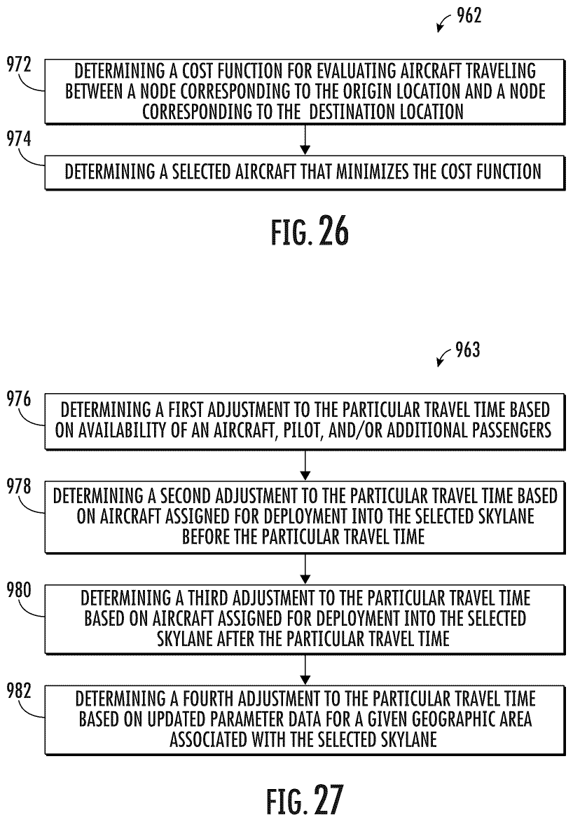

At step 962, a computing system can compute a selected aircraft from the plurality of candidate aircraft for servicing the trip request at the particular travel time. Further aspects of computing a selected aircraft at step 964 are described with reference to FIG. 26.

At step 963, a computing system can compute a departure time for deployment of the aircraft from the origin location into the selected skylane. Further aspects of computing a departure time for deployment of the aircraft at step 966 are described with reference to FIG. 27.

At step 964, a computing system can access updated parameter data at a time subsequent to the generation of the trip assignment at step 959 of FIG. 23A. In some implementations, the parameter data accessed at step 924 can include updated parameter data 674 of FIG. 6. For instance, if the parameter data evaluated at step 956 included estimated parameter data defining expected operating parameters associated with a particular geographic area at a particular travel time, then the updated parameter data accessed at step 964 can define current, real-time, or near real-time operating parameters, or at least parameters sampled closer to the particular travel time.

At step 965, a computing system can compute the selected skylane from the candidate skylanes for servicing the trip request at the particular travel time based on the updated parameter data accessed at step 964. Step 965 can be similar to step 958, further aspects of which are described with reference to FIG. 24.

At step 966, a computing system can generate an updated trip assignment for deployment of the aircraft from the origin location into the selected skylane. The updated trip assignment generated at 966 can be similar to step 959, but updated to include any additional changes based on the updated parameter data accessed at step 964 and or recomputation of a selected skylane at step 965.

At step 967, a computing system can provide deployment instructions to initiate takeoff of the eVTOL aircraft into the selected skylane to fulfill the trip assignment. Providing deployment instructions at step 967 can serve to effectively deploy an eVTOL aircraft by initiating motion or launch of the eVTOL aircraft. Deployment instructions can be provided at step 967 to: (i) a pilot operating the eVTOL aircraft and/or (ii) a control system onboard the eVTOL aircraft.

FIG. 24 depicts a flowchart diagram of an example method for computing a selected skylane from candidate skylanes according to example embodiments of the present disclosure. The method of FIG. 24 provides an example of additional operations associated with step 958 of FIG. 23A.

At step 970, a computing system can assign one or more weights to the nodes and/or edges within a directed graph representation of the skylane network.

At step 972, a computing system can determine a cost function for a travel path defined between a node corresponding to the origin location and a node corresponding to the destination location. In some instances, the cost function can be determined based on graph theory, such as a cost function defined in terms of determining a shortest path between nodes. Cost functions can be defined using one or more algorithms for determining shortest paths in a graph, including but not limited to Dijkstra's algorithm, Bellman-Ford algorithm, Floyd-Marshall algorithm, Johnson's algorithm, Viterbi algorithm, etc.

At step 974, a computing system can determine a path in the directed graph representation that optimizes (e.g., minimizes) the cost function. In some examples, determining a path at 974 can include determining a path between two nodes in a directed graph representation such that the sum of the weights of its constituent edges are minimized.

FIG. 25 depicts a flowchart diagram of an example method of computing a plurality of candidate aircraft from a fleet of aircraft for servicing a trip request according to example embodiments of the present disclosure. The method of FIG. 25 provides an example of additional operations associated with step 961 of FIG. 23B.

At step 976, a computing system can determine in a first iteration whether an operating constraint for a particular aircraft is satisfied based on estimated parameter data.

At step 978, a computing system can determine in a second iteration whether an operating constraint for a particular aircraft is satisfied based on estimated parameter data.

At step 980, a computing system can determine a particular aircraft as satisfying or violating an associated operating constraint based on the first iteration implemented in step 976 and/or the second iteration implemented in step 978.

FIG. 26 depicts a flowchart diagram of an example method of computing a selected aircraft from the plurality of candidate aircraft for servicing a trip request according to example embodiments of the present disclosure. The method of FIG. 26 provides an example of additional operations associated with step 962 of FIG. 23B.

At step 972, a computing system can determine a cost function for evaluating aircraft traveling between a node corresponding to the origin location and a node corresponding to the destination location.

At step 974, a computing system can determine a selected aircraft that minimizes the cost function determined at step 972.

FIG. 27 depicts a flowchart diagram of an example method of computing a departure time for deployment of a selected aircraft according to example embodiments of the present disclosure. The method of FIG. 27 provides an example of additional operations associated with step 963 of FIG. 23B. Departure times can be computed at step 963 based on one or more adjustments to a particular travel time (e.g., a travel time associated with the trip request).

At step 976, a computing system can determine a first adjustment to the particular travel time based on availability of an aircraft, pilot, and/or additional passengers. For instance, although a particular passenger may request a particular travel time, that time may need to be adjusted sooner or later based on an arrival time at a departure vertiport of an aircraft, pilot, and/or additional passengers assigned to the same aircraft.

At step 978, a computing system can determine a second adjustment to the particular travel time based on aircraft assigned for deployment into the selected skylane before the particular travel time. For instance, if another aircraft is assigned for deployment into the same skylane thirty seconds before a particular travel time and one minute is required between aircraft deployments, then the departure time 666 for selected aircraft 664 can be adjusted later by thirty seconds or more to accommodate the required spacing.

At step 980, a computing system can determine a third adjustment to the particular travel time based on aircraft assigned for deployment into the selected skylane after the particular travel time. For instance, if another aircraft is assigned for deployment into the same skylane thirty seconds after a particular travel time and one minute is required between aircraft deployments, then the departure time 666 for selected aircraft 664 can be adjusted earlier by thirty seconds or more to accommodate the required spacing between successive deployments.

At step 982, a computing system can determine a fourth adjustment to the particular travel time based on updated parameter data for a particular geographic area associated with the selected skylane. For instance, if updated parameter data indicates a weather condition associated with the selected skylane 662 at a particular travel time, then departure time 666 can be adjusted to a time when the parameter data is predicted to change and satisfy an operating constraint of the skylane.

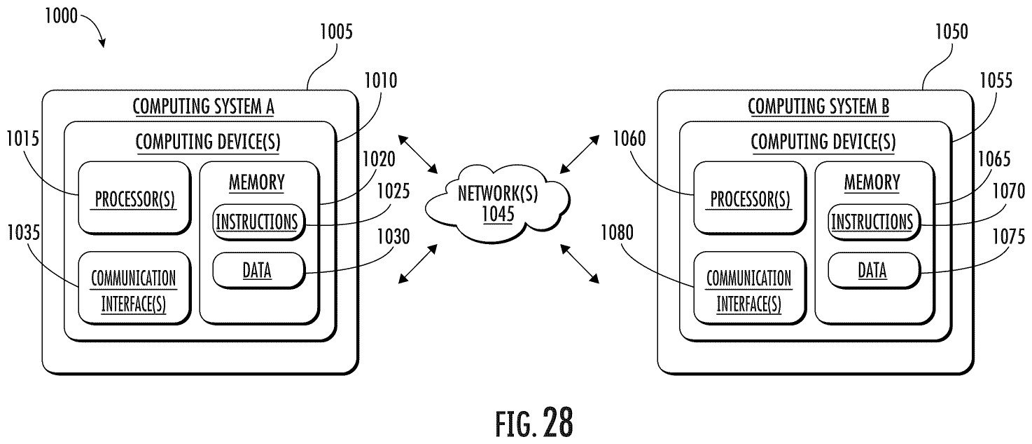

FIG. 28 depicts example system components of an example system 1000 according to example implementations of the present disclosure. The example system 1000 can include a computing system 1005 and a computing system 1050 that are communicatively coupled over one or more networks 1045. The computing systems 1005 and 1050 can represent, for example, computing systems that are onboard or offboard an aircraft, a cloud computing system, user computing system, or other systems/devices described herein.

The computing system 1005 can include one or more computing devices 1010. The computing devices 1010 of the computing system 1005 can include one or more processors 1015 and a memory 1020. The processors 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 can store information that can be accessed by the processors 1015. For instance, the memory 1020 (e.g., one or more non-transitory computer-readable storage mediums, memory devices) can include computer-readable instructions 1025 that can be executed by the processors 1015. The instructions 1025 can be software written in any suitable programming language or can be implemented in hardware. Additionally, or alternatively, the instructions 1025 can be executed in logically and/or virtually separate threads on processors 1015.

For example, the memory 1020 can store instructions 1025 that when executed by the processors 1015 cause the processors 1015 to perform operations such as any of the processes/methods described herein or any of the operations and functions of any of the computing systems (e.g., aerial transportation platform system, ground transportation platform system, third-party provider system, airspace system, computing system 1005, etc.) and/or computing devices (e.g., user devices, ground vehicle devices, aircraft devices, aerial facility devices facility operator user devices, computing device 1010, etc.), as described herein.

The memory 1020 can store data 1030 that can be obtained, received, accessed, written, manipulated, created, and/or stored. The data 1030 can include, for instance, any of the data/information described herein. In some implementations, the computing devices 1010 can obtain from and/or store data in one or more memory devices that are remote from the computing system 1005 such as one or more memory devices of the computing system 1050.

The computing devices 1010 can also include a communication interface 1035 used to communicate with one or more other systems (e.g., computing system 1050). The communication interface 1035 can include any circuits, components, software, etc. for communicating via one or more networks (e.g., 1045). In some implementations, the communication interface 1035 can include for example, one or more of a communications controller, receiver, transceiver, transmitter, port, conductors, software and/or hardware for communicating data/information.

The computing system 1050 can include one or more computing devices 1055. The computing devices 1055 can include one or more processors 1060 and a memory 1065. The one or more processors 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more non-transitory computer-readable storage media, such as RAM, ROM, EEPROM, EPROM, one or more memory devices, flash memory devices, etc., and combinations thereof.

The memory 1065 can store information that can be accessed by the processors 1060. For instance, the memory 1065 (e.g., one or more non-transitory computer-readable storage mediums, memory devices) can store data 1075 that can be accessed e.g., obtained, received, written, manipulated, created, stored, pulled, etc. The data 1075 can include, for instance, any data or information described herein. In some implementations, the computing system 1050 can obtain data from one or more memory devices that are remote from the computing system 1050.

The memory 1065 can also store computer-readable instructions 1070 that can be executed by the processors 1060. The instructions 1070 can be software written in any suitable programming language or can be implemented in hardware. Additionally, or alternatively, the instructions 1070 can be executed in logically and/or virtually separate threads on processors 1060. For example, the memory 1065 can store instructions 1070 that when executed by the processors 1060 cause the processors 1060 to perform any of the operations and/or functions described herein, including, for example, any of the processes/methods described herein or the operations and functions of any of the computing systems (e.g., aerial transportation platform system, ground transportation platform system, third-party provider system, airspace system, computing system 1050, etc.) or computing devices (e.g., user devices, ground vehicle devices, aircraft devices, aerial facility devices facility operator user devices, computing device 1055, etc.), as described herein.

The computing devices 1055 can also include a communication interface 1080 used to communicate with one or more other systems. The communication interface 1080 can include any circuits, components, software, etc. for communicating via one or more networks (e.g., 1045). In some implementations, the communication interface 1080 can include for example, one or more of a communications controller, receiver, transceiver, transmitter, port, conductors, software and/or hardware for communicating data/information.

The networks 1045 can be any type of network or combination of networks that allows for communication between devices. In some implementations, the networks 1045 can include one or more of a local area network, wide area network, the Internet, secure network, cellular network, mesh network, peer-to-peer communication link and/or some combination thereof and can include any number of wired or wireless links. Communication over the networks 1045 can be accomplished, for instance, via a network interface using any type of protocol, protection scheme, encoding, format, packaging, etc.

FIG. 28 illustrates one example system 1000 that can be used to implement the present disclosure. Other computing systems can be used as well. Computing tasks discussed herein as being performed at computing devices remote from a vehicle/device can instead be performed at the vehicle/device, or vice versa. Such configurations can be implemented without deviating from the scope of the present disclosure.

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. The term “or” should be understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

What is claimed is:

1. A method of assigning an electric vertical takeoff and landing (eVTOL) aircraft to a skylane, the method comprising:
accessing trip request data defining a trip request for aerial transport at a particular travel time from an origin location to a destination location within a particular geographic area;
accessing skylane network data indicative of a plurality of skylanes for eVTOL aircraft travel in the particular geographic area;
computing a subset of the plurality of skylanes as candidate skylanes for servicing the trip request, wherein the candidate skylanes are determined based on a route assessment configured to evaluate an operating constraint associated with respective skylanes relative to parameter data for the particular geographic area at the particular travel time;
computing a selected skylane from the candidate skylanes for servicing at least a portion of the trip request; and
generating a trip assignment for deployment of an eVTOL aircraft from the origin location into the selected skylane.

2. The method of claim 1, wherein:
the plurality of skylanes are respectively depicted as a directed graph representation of nodes and edges; and
computing a selected skylane from the candidate skylanes for servicing at least a portion of the trip request comprises determining a path along edges in the directed graph representation that minimize a cost function between a node corresponding to the origin location and a node corresponding to the destination location.

3. The method of claim 1, wherein computing a selected skylane from the candidate skylanes for servicing at least a portion of the trip request at the particular travel time is based on historical trip data indicative of previous trips between the origin location and the destination location.

4. The method of claim 1, further comprising:
computing a plurality of candidate aircraft from a fleet of aircraft for servicing the trip request at the particular travel time, wherein the plurality of candidate aircraft are determined based on an aircraft assessment configured to evaluate an operating constraint associated with respective aircraft of the fleet of aircraft relative to parameter data for the particular geographic area at the particular travel time; and
computing a selected aircraft from the plurality of candidate aircraft for servicing the trip request at the particular travel time;
wherein generating the trip assignment for deployment of the eVTOL aircraft from the origin location into the selected skylane is configured for deployment of the selected aircraft.

5. The method of claim 1, further comprising:
computing a departure time for deployment of the eVTOL aircraft from the origin location into the selected skylane, the departure time determined based on the particular travel time and updated parameter data associated with the plurality of skylanes at the particular travel time.

6. The method of claim 1, wherein the operating constraint associated with respective skylanes of the plurality of skylanes comprises a type of eVTOL aircraft designated for travel on the respective skylanes of the plurality of skylanes.

7. The method of claim 1, wherein the operating constraint associated with respective skylanes of the plurality of skylanes comprises a speed for eVTOL aircraft designated for travel on the respective skylanes of the plurality of skylanes.

8. The method of claim 1, wherein the operating constraint associated with respective skylanes of the plurality of skylanes comprises a noise limit defining a threshold visual noise level or a threshold audible noise level established for the particular geographic area.

9. The method of claim 1, wherein the operating constraint associated with respective skylanes of the plurality of skylanes comprises a weather condition limit defining an acceptable level of a temperature, a pressure, a wind condition, or a visibility condition established for the particular geographic area.

9. The method of claim 1, wherein computing a subset of the plurality of skylanes as candidate skylanes for servicing the trip request comprises:
implementing a first computing iteration based on predicted parameter data for the particular geographic area at the particular travel time; and
implementing a second skylane iteration based on real-time parameter data for the particular geographic area at the particular travel time.

10. The method of claim 1, wherein the parameter data comprises location parameter data defining takeoff and landing paths for other aircraft operating in the particular geographic area.

11. The method of claim 1, wherein the parameter data comprises noise level data defining a visual noise level or an audible noise level determined for the particular geographic area.

12. The method of claim 1, wherein the parameter data comprises weather data defining of at least one of a temperature, a pressure, a wind condition, or a visibility condition determined for the particular geographic area.

13. The method of claim 1, wherein the parameter data comprises location data from an application associated with a pilot or a passenger currently traveling on a particular skylane of the plurality of skylanes.

14. The method of claim 1, further comprising:
accessing updated parameter data at a time subsequent to the generating of the trip assignment;
computing the selected skylane from the candidate skylanes for servicing at least a portion of the trip request at the particular travel time based on the updated parameter data; and
generating an updated trip assignment for deployment of the eVTOL aircraft from the origin location into the selected skylane.

15. The method of claim 1, further comprising:
providing deployment instructions to initiate takeoff of the eVTOL aircraft into the selected skylane to fulfill the trip assignment.

16. One or more non-transitory computer-readable media storing instructions that are executable by one or more processors to perform operations, the operations comprising:
accessing trip request data defining a trip request for aerial transport at a particular travel time from an origin location to a destination location within a particular geographic area;
accessing skylane network data indicative of a plurality of skylanes for electric vertical takeoff and landing (eVTOL) aircraft travel in the particular geographic area;
computing a subset of the plurality of skylanes as candidate skylanes for servicing the trip request, wherein the candidate skylanes are determined based on a route assessment configured to evaluate an operating constraint associated with respective skylanes relative to parameter data for the particular geographic area at the particular travel time;
computing a selected skylane from the candidate skylanes for servicing at least a portion of the trip request; and
generating a trip assignment for deployment of an eVTOL aircraft from the origin location into the selected skylane.

17. The one or more non-transitory computer-readable media of claim 16, wherein:
the plurality of skylanes are respectively depicted as a directed graph representation of nodes and edges; and
computing a selected skylane from the candidate skylanes for servicing at least a portion of the trip request comprises determining a path along edges in the directed graph representation that minimize a cost function between a node corresponding to the origin location and a node corresponding to the destination location.

18. The one or more non-transitory computer-readable media of claim 16, wherein computing a selected skylane from the candidate skylanes for servicing at least a portion of the trip request at the particular travel time is based on historical trip data indicative of previous trips between the origin location and the destination location.

19. A computing system, comprising:
one or more processors; and
one or more non-transitory computer-readable media storing instructions that are executable by the one or more processors to perform operations, the operations comprising:
accessing trip request data defining a trip request for aerial transport at a particular travel time from an origin location to a destination location within a particular geographic area;
accessing skylane network data indicative of a plurality of skylanes for electric vertical takeoff and landing (eVTOL) aircraft travel in the particular geographic area;
computing a subset of the plurality of skylanes as candidate skylanes for servicing the trip request, wherein the candidate skylanes are determined based on a route assessment configured to evaluate an operating constraint associated with respective skylanes relative to parameter data for the particular geographic area at the particular travel time;
computing a selected skylane from the candidate skylanes for servicing at least a portion of the trip request; and
generating a trip assignment for deployment of an eVTOL aircraft from the origin location into the selected skylane.

20. The computing system of claim 19, wherein:
the plurality of skylanes are respectively depicted as a directed graph representation of nodes and edges; and
computing a selected skylane from the candidate skylanes for servicing at least a portion of the trip request comprises determining a path along edges in the directed graph representation that minimize a cost function between a node corresponding to the origin location and a node corresponding to the destination location.
